(19) United States
(12) Patent Application Publication
(10) Pub. No.: US 2007/0219330 A1
(43) Pub. Date: Sep. 20, 2007

(54) Amide initiators

(76) Inventors: David M. Haddleton, Kenilworth (GB); Adam John Limer, Warrington (GB); Andrew G. Steward, Cubbineton (GB)

Correspondence Address: ELMORE PATENT LAW GROUP, PC, 209 MAIN STREET, N. CHELMSFORD, MA, 01863, US

(21) Appl. No.: 11/654,400

(22) Filed: Jan. 17, 2007

Related U.S. Application Data
(60) Provisional application No. 60/809,594, filed on May 31, 2006.

(30) Foreign Application Priority Data
Jan. 17, 2006 (GB) GB0600915.3

(51) Int. Cl. C08F 4/00

(52) U.S. Cl. 526/217; 526/223; 526/319; 526/346; 526/341; 526/317.1

(57) ABSTRACT

The invention relates to a transition metal living free radical and/or atom transfer polymerisation process comprising the steps of: (a) mixing (i) a transition metal living free radical and/or atom transfer radical catalyst, (ii) a plurality of polymerisable monomers, and (iii) an initiator comprising a transferable atom or group a to an amide group to form a mixture; (b) incubating the mixture at a first temperature; and then (c) raising the temperature of the mixture to a second temperature to allow polymerisation of the monomers to proceed to produce polymer. Products and initiators are also provided.

### RELATED APPLICATION

This application claims the benefit of U.S. Provisional Application No. 60/809,594, filed on May 31, 2006 and United Kingdom Patent Application No. GB0600915.3, filed on Jan. 17, 2006. The entire teachings of the above applications are incorporated herein by reference.

### BACKGROUND OF THE INVENTION

Transition metal mediated living radical polymerization (LRP) (often called ATRP) has emerged as an effective technique for the controlled polymerization of styrenics, methacrylates, acrylates and acrylonitrile.¹⁻³ This technique has been the subject of many papers as it offers the opportunity to prepare a diverse range of functional polymers. A wide variety of moieties have been utilized as initiators including alkyl halides,⁴⁻⁷ benzylic halides,⁸⁻¹⁰ haloesters,^{6,7,11,12} haloketones,^{7,13,14} halonitriles^{15,16} and sulfonyl halides¹⁷⁻¹⁹ as well as polyhalogenated compounds.²⁰⁻²³ This type of living radical polymerization requires an activated C—X bond (where X is usually a halogen) alpha to an electron withdrawing group, initiation occurs following homolytic fission of the C—X bond. The choice of initiator is important in controlling the rate of initiation; if the C—X bond is too strong initiation, and thus polymerization, will not take place and if the C—X bond is too weak a free radical will be produced that results in a high concentration of radicals leading to either premature termination or polymer with broadened polydispersity. To maintain the characteristics of a useful living polymerization with narrow polydispersity, the ability for re-initiation to give block copolymers it is important to maintain the rate of initiation at least comparable to the rate of propagation.

There have been many reported examples of the transformation of hydroxyl functionality into polymerization initiators via an appropriate esterification. Resulting in molecules with one initiator site per hydroxyl group. Derivatives of cholesterol²⁰, sugars^{21,24}, cyclodextrins²⁵, Wang resins,²²⁻²⁶ fluorinated molecules²⁷ and various preformed polymers such as poly(ethylene glycol),^{23,28} poly(dimethyl siloxane)²⁹ and poly(tetrahydrofuran)³⁰ have been used to prepare many novel structures including block and star copolymers. Conversely there have been few examples of primary amines being converted into initiators to give 2-bromo-2-methyl-propionamide based initiators. Sawamoto et al, reported the use of N,N-dimethyl-2-chloropropanamide in the polymerization of dimethylacrylamide in an attempt to mimic the structure of the propagating polymer structure with a similar initiator composition.³¹ Polymeric products were of desired molecular weight, although polydispersity was relatively broad (˜1.6). Only one report by Kang et al, describes the conversion of a primary amine into an initiator for ATRP.³² An amino functional silicone surface was reacted with 2-bromoisobutyryl bromide to create initiator sites which was used for the polymerization of poly(ethylene glycol)methyl ether methacrylate (PEGMA) and N-isopropylacrylamide. However, no attempt was made to determine the molecular weight properties of the polymer produced. Indeed in a paper describing the polymerization of (meth)acrylamides by ATRP, Matyjaszewski utilized ester derived initiators.³³ Previous investigations have shown that polymers formed using bromo-2-methyl-propionamide initiators with acrylamides (Kamigaito M., CHEM. REV. 2001, 101: 3689-3745) have tended to be of low polydispersity but with molecular weights differing considerably from the predicted. This is most likely caused by large amounts of termination occurring at the start of the reaction during the initiation phase. The result of this is a polymer with a molecular weight considerably greater than the theoretical value. It must also be noted that the two complementary living radical polymerization techniques have also been extensively developed for the synthesis of complex polymer architectures. Poly(dimethyl siloxane) triblock copolymers have been reported by Davis as well as more complex architectures^{34 35} whilst Perrier has developed a facile route to quite complex initiators which in turn give rise to diverse polymer structures^{36 37} including supported initiators³⁸. Nitroxide mediated radical polymerization also been widely developed, especially for styrenes and acrylate monomers^{39 40} but not so successfully for methacrylates.

WO 96/30421 and WO 97/18247 disclose processes of atom or group transfer radical polymerisation using an initiator having a radically transferable group or atom, a transition metal compound and a ligand such as bipyridine. A very large number of possible different initiators are suggested, but amide initiators are not explicitly disclosed or indeed suggested.

WO 97/47661 discloses organodiimine based catalysts for addition polymerisation, wherein at least one of the nitrogens on the diimine is not a part of an aromatic ring. Again, a number of initiators are disclosed, but not the amide initiators of the invention described below.

WO 98/01480 discloses utilising macroinitiators to produce block or graft copolymers.

WO 00/52061 discloses initiators for controlled polymerisation reactions comprising silane groups. Amide containing initiators are disclosed. The initiator catalyst and monomers are mixed and immediately heated to reaction temperature.

When initiators are used in living free radical and/or atom transfer polymerisation, the initiator and the atom that leaves the activated C—X group (“X”) eventually become attached or incorporated into the resulting polymer (see Scheme 2 in the Results section below). This has been utilised to allow the growth of polymers on supports by utilising an initiator attached to a support via, for example, a selectively cleavable link, see WO 01/94424. This shows that the initiator may be selectively removed from the support by using a selectively cleavable linking bond, such as an acid labile ester bond.

However, it may be desirable to keep the initiator attached to the polymer, for example where it is useful to have the polymer attached to a support or where the initiator itself contains a functional group, such as a fluorescent labelling group. Ester bonds, if used in the body, for example, are generally cleavable by esterases. The inventors have realised that amides are more hydrolytically stable. However, amide-based initiators, as indicated above, have proved difficult to utilise effectively.

### SUMMARY OF THE INVENTION

The invention relates to living radical polymerisation using amide initiators, to the initiators, and polymers produced by the process.

The inventors have now carried out work which exemplifies the preparation of bromo-2-methyl-propionamide initiators for methacrylate polymerization via copper mediated LRP. Reaction conditions have been optimized for the synthesis of poly(methacrylates) and poly(styrene) of desired molecular weight with low polydispersity. Two initiators were used based on benzyl amine and the amino acid L-alanine. The synthesis of both homo and block copolymers is discussed. The synthesis of block copolymers from a preformed amino functional polymeric macroinitiator is also described. Further work has also been carried out to confirm these initial findings.

They have unexpectedly found that it is possible to control the average molecular weight and narrow polydispersity of the resulting polymer by slowing down the initiation step in which the activated atom alpha to the amide of an initiator is transferred to a monomer.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows a first order kinetic plot for the polymerization of MMA using a Cu(I)Cl catalyst [MMA]/[CuCl]/[ligand]/[1]=100/1/2/1 in toluene solution (50 vol %), To=25° C., held for 30 minutes then heated to and subsequently held at 90° C. for 6/7 hours. ▪ and solid line=initiator 1. ◯ and dashed line=initiator 2.

FIG. 2 shows Mₙ vs conversion for the preparation of PMMA using a Cu(I)Cl catalyst [MMA]/[CuCl]/[ligand]/[1]=100/1/2/1 in toluene solution (50 vol %), To=25° C. subsequently held at 90° C. for 6 hours. ▪=initiator 1. ◯=initiator 2.

FIG. 3 shows ¹H NMR spectra of initiator 1 (bottom) and d⁸-MMA polymer initiated with 1 (top).

FIG. 4 shows ¹³C NMR spectra of carbon chlorine bond at ω-chain end.

FIG. 5 shows SEC Trace of a PMMA Macroinitiator and a PMMA-b-PDMAEMA Block Copolymer.

FIG. 6 shows (a) First order Kinetic Plot for the Preparation of a PMMA-PDMS-PMMA Triblock Copolymer, (b) evolution of Mₙ and PDI with conversion for the polymerisation of MMA form PDMS macroinitiator.

### DETAILED DESCRIPTION OF THE INVENTION

A first aspect of the invention provides a transition metal living free radical and/or atom transfer polymerisation process comprising the steps of:
(a) mixing (i) a transition metal living free radical and/or atom transfer radical catalyst, (ii) a plurality of polymerisable monomers, and (iii) an initiator comprising a transferable atom or group α to an amide group to form a mixture;
(b) incubating the mixture at a first temperature; and then
(c) raising the temperature of the mixture to a second, higher, temperature to allow polymerisation of the monomers to proceed to produce polymer.

That is, the transferable atom or group is usually attached to a carbon atom α to an amide group.

Transition metal living free radical catalysts and/or atom transfer radical catalysts are themselves well known in the art. Suitable catalysts are disclosed, for example, in WO 96/30421, WO 97/18247, WO 97/47661, WO 98/01480 and WO 01/94424, incorporated herein by reference.

The plurality of polymerisable monomers may be a number of separate monomers of the same type, for example acrylate, styrene or methacrylate, or alternatively a mixture of different types of monomers, for example a mixture of methacrylate and acrylate monomers.

The initiator may be any suitable initiator comprising a transferable atom or group α to an amide group. As discussed above, the transferable atom or group is attached to the initiator via an activated C—X bond. Initiation occurs following homolytic or free radical fission of the C—X bond.

The process of the invention comprises incubating the mixture at a first temperature, and then raising the temperature to a second, higher, temperature. The inventors have found that incubating the mixture at a first temperature reduces the rate of the initiation step in which the transferable atom or group α to the amide is transferred to the monomer, giving better control of the reaction. Some polymerisation of the monomers may occur at this lower temperature. However, the bulk of the polymerisation will occur upon raising the temperature to allow polymerisation of the monomers to proceed to produce polymer.

Preferably, the temperature of the mixture is raised by at least 40° C., more preferably at least 45° C., at least 50° C., at least 60° C., at least 70° C., at least 80° C., at least 90° C., more preferably at least 100° C., depending on the conditions required to optimise the production of the polymer.

Preferably, the first temperature is between −20° C. and 40° C., especially between 0° C. and 35° C., more preferably between 15° C. and 30° C., preferably 20° C. to 25° C., especially 25° C. or ambient temperature.

The initiation step may additionally be limited by the addition of transition metal in a higher oxidation state than the metal used in the catalyst. For example, Cu(I) is often used as the transition metal in catalysts of the sort used in the invention. Cu(II) may be added to reduce the rate of both the initiation and propagation steps by acting to push the chemical equilibrium towards Cu(I) and a stable C—X bond which is inert towards monomer addition.

Preferably the molar ratio of Cu(I): Cu(II) is between 100:1 to 100:1.

Catalysts will usually utilise a transition metal ion with a halide counterion. Preferably the halide counterion is chloride, rather than bromide. For example, CuCl is preferably used in place of CuBr, as this has also been found to reduce the rate at which the initiation reaction occurs.
Preferably the initiator has a general formula:

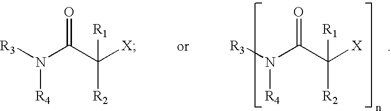

X is selected from Cl, Br, I, OR²⁰, SR²¹, SeR²¹, OP(═O)R²¹, OP(═O)R²¹, OP(═O)(OR²¹)₂, OP(═O)O²¹, O—N(R²¹)₂ and S—C(═S)N(R²¹)₂, where R²⁰=a C₁ to C₂₀ alkyl where one or more of the hydrogen atoms may be independently replaced by halide, R²¹ is aryl or a straight or branched C₁-C₂₀ alkyl group, and where an (NR²¹)₂ group is present, the two R²¹ groups may be joined to form a 5- or 6-membered heterocyclic ring; and

R₁, R₂, R₃ and R₄ are each independently selected from H, halogen, C₁-C₂₀ alkyl, C₃-C₈ cycloalkyl, C═YR²², C(═Y)NR²³R²⁴, COCl, OH, CN, C₂-C₂₀ alkenyl, C₂-C₂₀ alkynyl, oxiranyl, glycidyl, aryl, heterocyclyl, aralkyl, aralkenyl, C₁-C₆ alkyl in which 1 or more hydrogen atoms are replaced with halogen, substituted or non-substituted C₁ to C₂₀ alkyl interrupted by a disulphide link and C₁ to C₆ alkyl substituted with from 1 to 3 substitutions selected from alkoxyl, aryl, heterocyclyl, C(═Y)R²², C(═Y)R²³R²⁴, oxiranyl, glycidyl;

where R²² is C₁ to C₂₀ alkyl, C₁ to C₂₀ alkoxy, aryloxy or heterocyclyloxy; and

R²³ and R²⁴ are independently H, C₁ to C₂₀ alkyl, or R²³ and R²⁴ may be joined together to form an alkylene group of 2 to 5 carbon atoms, thus forming a 3- to 6-membered ring;

where Y may be NR²⁵ or O, and R²⁵ is H, straight or branched C₁ to C₂₀ alkyl or aryl;

such that preferably no more than three or no more than two of R₁, R₂, R₃ and R₄ are H, and wherein R₃ and/or R₄ may additionally be a functional group or a linker attached to a functional group, a polymer and/or a macromolecule; n is an integer of 2 to 100 (preferably 2, 3 or 4); and salts thereof.

R₃ or R₄ is preferably a substituted or non-substituted, straight or branched chain alkyl, polyester or polyether, preferably containing 1 to 20 carbon atoms; preferably substituted with —COOH, —OH, ═O, S, —NH₂, substituted or non-substituted aryl, methyl, ethyl or halogen.

The linker may be any suitable moiety connecting, for example, the amide part of the initiator to a functional group. Suitable linkers include substituted or non-substituted alkyls. The linker may comprise one or more selectively cleavable links, such as a selectively cleavable covalent bond. Suitable selectively cleavable links include acid labile groups, including ester groups, to allow the finished polymer to be released from, for example, a support.

The functional group may be a support. Suitable supports are described, for example, in WO 01/94424. The support may be in the form of a sheet or bead. Beads are especially preferable, since they have a high surface area. The support may be made of an inorganic material such as silica. Alternatively, the support may be an organic material such as a cross-linked organic polymer. Most preferably, the support is a poly(styrene-w-divinylbenzone), for example of the sort known as Wang resins. Such supports may comprise a plurality of amide moieties.

R₃ and R₄ may additionally be a macromolecule. The production of macro initiators using macro molecules attached to initiator moieties is described in detail in WO 98/01480. Such macro initiators comprise a macromolecule attached to a plurality of initiator moieties. Hence, R₃ and/or R₄ is preferably a macromolecule.

Where R₃ or R₄ is a macromolecule or a support, for example, a plurality of initiator groups may be attached to the support or macromolecule, optionally each via a separate linkage of the sort preferably described above.

R₄ is preferably H.

Preferably, the macromolecule has a number average molecular weight of at least 500.

The macromolecule and/or polymer may comprise or be made of substituted or non-substituted siloxane monomers, such as methyl siloxane or siloxane monomers. Alternatively, the macromolecule may be made of a plurality of olefinically unsaturated monomers.

Preferably the monomer used to make the macromolecules or polymer making up R³ or R₄ is methacrylate, acrylate or styrene. Acrylamide, methacrylamide or acrylonitrile may also be used. Alternative monomers also include dienes such as butadiene, vinylether or vinylacetate.

Preferably

R₁=methyl

R₂=H or methyl

R₃=H

R₄=—(CH₂)ₘ—S—S—C(CH₃)₃

where m=an integer of 1 to 16, preferably 1, 2 or 3.

Examples of olefinically unsaturated monomers that may be polymerised to make the polymer or macromolecule, R₃ and/or R₄, include methyl methacrylate, ethyl methacrylate, propyl methacrylate (all isomers), butyl methacrylate (all isomers), and other alkyl methacrylates; corresponding acrylates; also functionalised methacrylates and acrylates including glycidyl methacrylate, trimethoxysilyl propyl methacrylate, allyl methacrylate, hydroxyethyl methacrylate, hydroxypropyl methacrylate, dialkylaminoalkyl methacrylates; nitrophenol (meth)acrylates; fluoroalkyl (meth)acrylates; methacrylic acid, acrylic acid; fumaric acid (and esters), itaconic acid (and esters), maleic anhydride; styrene, α-methyl styrene; vinyl halides such as vinyl chloride and vinyl fluoride; acrylonitrile, methacrylonitrile; vinylidene halides of formula CH₂═C(Hal)₂ where each halogen is preferably independently Cl or F; optionally substituted butadienes of the formula CH₂═C(R¹⁵)C(R¹⁵)═CH₂ where R¹⁵ is independently H, C₁ to C₁₀ alkyl, Cl, or F; sulphonic acids or derivatives thereof of formula CH₂═CHSO₂OM wherein M is Na, K, Li, N(R¹⁶)₄ where each acrylamide or derivatives thereof of formula CH₂═CHCON(R¹⁶)₂ and methacrylamide or derivative thereof of formula CH₂═C(CH₃)CON(R¹⁶)₂, R¹⁶ is independently H or Cl or alkyl, D is COZ, ON, N(R¹⁶)₂ or SO₂OZ and Z is H, Li, Na, K or N(R¹⁶)₄. Mixtures of such monomers may be used. R₃ or R₄ is preferably substituted or non-substituted, branched or straight chain alkyl, polyester, polyether, or an AB copolymer thereof, preferably containing 1 to 20 carbon atoms; optionally substituted with —COOH, —OH, —O, S, —NH₂, substituted or non-substituted aryl, methyl, ethyl or halogen.

Preferably, the monomers used in any aspect of the invention are commercially available and may contain a free-radical inhibitor such as 2,6-di-tert-butyl-4-methylphenol or methoxyphenol.

Macro initiators may be used to make, for example, block or graft copolymers.

Preferably, the functional group is a detectable label, such as a fluorescent moiety. This allows the polymer to be coloured or detected. Alternatively, the detectable moiety may be a latex bead or other such coloured particle.

Preferably, the initiator is selected from N-benzyl-2-bromo-2-methyl-propionamide, L-alanine-methylester-2-bromo-2-methyl-propionamide, or a difunctional bromoamide poly(dimethylsiloxane).
Preferably the initiator is selected from:

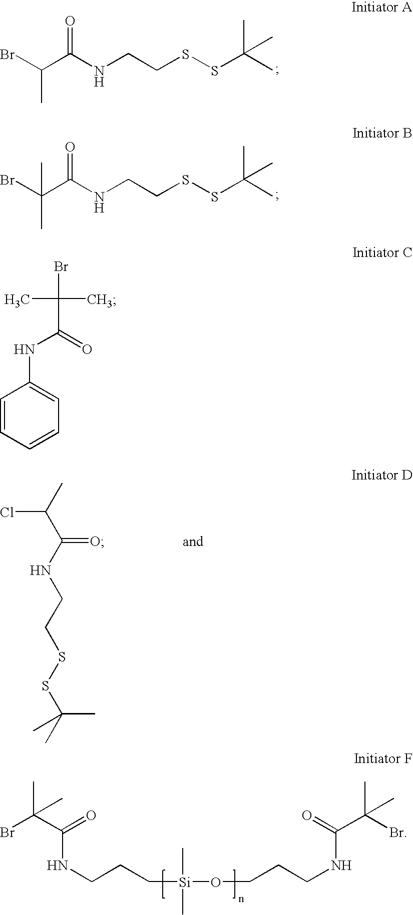

The mixture may be freeze-pump-thawed one or more times prior to incubation at the first temperature to deoxygenate the mixture. Preferably, the mixture is freeze thawed 1-5 times, especially 3 times.

Preferably, the mixture is mixed under nitrogen using deoxygenated components.

The first temperature may be a fixed temperature for a predetermined amount of time. The inventors have found that the temperature may also be slowly raised to the higher reaction temperature.

The mixture is preferably incubated for 1 minute, preferably at least 5 minutes at the first temperature. More preferably the amount of time for which the mixture is incubated is at least 10, at least 20, at least 30, at least 40, at least 50, preferably at least 60 minutes. The maximum time that the mixture is incubated is preferably less than 120, less than 100, less than 80, preferably less than 60 minutes.

The temperature is preferably raised from the first temperature to the second temperature at a slow rate. For example, the rate of temperature change is preferably between 0.1° C. min.⁻¹ to 100° C. min.⁻¹, preferably between 1° C. and 10° C. rise per minute, most preferably 1° C. to 5° C., especially 1° C. to 2° C. per minute. This may be achieved simply by placing the reaction mixture in an oil bath at the first temperature and allowing the oil bath to heat up using a suitable heater to the reaction temperature.

Preferably, the amount of time that the reaction mixture is incubated for is 30 minutes at the first temperature.

The second temperature used is preferably adjusted to a suitable temperature to allow the polymerisation reaction to proceed properly. Polymerisation reaction may take between 1 and 12 hours, preferably between 2 and 10 hours, most preferably between 4 and 8 hours, or 5 and 7 hours.

Preferably, the method of the invention provides a catalyst comprising a ligand which is any N—, O—, P— or S— containing compound which can coordinate in a 6-bond to a transition metal or any carbon-containing compound which can coordinate in a π-bond to the transition metal, such that direct bonds between the transition metal and growing polymer radicals are not formed. Such catalysts are shown, for example, in WO 96/30421, incorporated herein by reference.

The catalyst may comprise a bipyridine. It may preferably comprise:

(a) a first compound
   MY

where: M is a transition metal having an oxidation state which is capable of being oxidised by one formal oxidation state,
Y is a mono, divalent or polyvalent counterion; and
(b) an organodiimine, where at least one of the nitrogens of the diimine is not part of an aromatic ring.

The catalyst may also comprise a first component of formula:
[MLₘ]ⁿ⁺Aⁿ⁻

where:
M=a transition metal having an oxidation state which is capable of being oxidised by one formal oxidation state,
L=an organodiimine where at least one of the nitrogens of the diimine is not part of an aromatic ring,
A=anion,
n=integer of 1 to 3,
m=an integer of 1 to 2.

Preferably, the transition metal is selected from Cu¹⁺, Cu²⁺, Fe²⁺, Fe³⁺, Ru²⁺, Ru³⁺, Cr²⁺, Cr³⁺, Mo²⁺, Mo³⁺, W²⁺, W³⁺, Mn³⁺, Mn⁴⁺, Ru³⁺, Ru⁴⁺, Re²⁺, Re³⁺, CO⁺, Co²⁺, V²⁺, V³⁺, Zn⁺, Zn²⁺, Au⁺, Au²⁺, Ag⁺ and Ag²⁺.

Preferably, copper chloride is used to provide the transition metal and counterion.

Preferably the organodiimine has a formula selected from:
1,4-diaza-1,3-butadiene

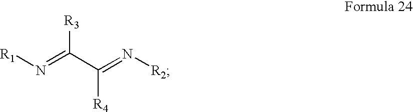

a 2-pyridinecarbaldehyde imine 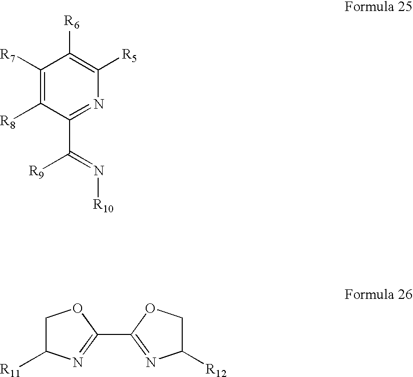
or a quinoline carbaldehyde 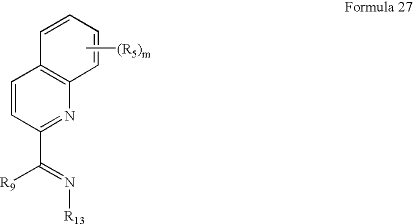
where R₁, R₂, R₁₀, R₁₁, R₁₂ and R₁₃ may be varied independently and R₁, R₂, R₁₀, R₁₁, R₁₂ and R₁₃ may be H, straight chain, branched chain or cyclic saturated alkyl, hydroxyalkyl, carboxyalkyl, aryl (such as phenyl or phenyl substituted where substitution is as described for R₄ to R₉), CH₂Ar (where Ar=aryl or substituted aryl) or a halogen. Preferably R₁, R₂, R₁₀, R₁₁, R₁₂ and R₁₃ may be a C₁ to C₂₀ alkyl, hydroxyalkyl or carboxyalkyl, in particular C₁ to C₄ alkyl, especially methyl or ethyl, n-propylisopropyl, n-butyl, sec-butyl, tert butyl, cyclohexyl, 2-ethylhexyl, octyl, decyl or lauryl.

R₁, R₂, R₁₀, R₁₁, R₁₂ and R₁₃ may especially be methyl.

R₃ to R₉ may independently be selected from the group described for R₁, R₂, R₁₀, R₁₁, R₁₂ and R₁₃ or additionally OCH₂ₙ₊ (where n is an integer from 1 to 20), NO₂, CN or O═CR (where R=alkyl, benzyl PhCH₂ or a substituted benzyl, preferably a C₁ to C₂₀ alkyl, especially a C₁ to C₄ alkyl) and where m is an integer from 0 to 4.

Preferably in the quinoline carbaldehyde, R₉ is H, and m=0.

Furthermore, the compounds may exhibit a chiral centre a to one of the nitrogen groups. This allows the possibility for polymers having different stereochemistry structures to be produced.

Compounds of general Formula 25 may comprise one or more fused rings on the pyridine group.

One or more adjacent R₁ and R₃, R₃ and R₄, R₄ and R₂, R₁₀ and R₉, R₈ and R₉, R₈ and R₇, R₇ and R₆, R₆ and R₅ groups may be C₅ to C₈ cycloalkyl, cycloalkenyl, polycycloalkyl, polycycloalkenyl or cyclicaryl, such as cyclohexyl, cyclohexenyl or norborneyl.

Preferred ligands include: 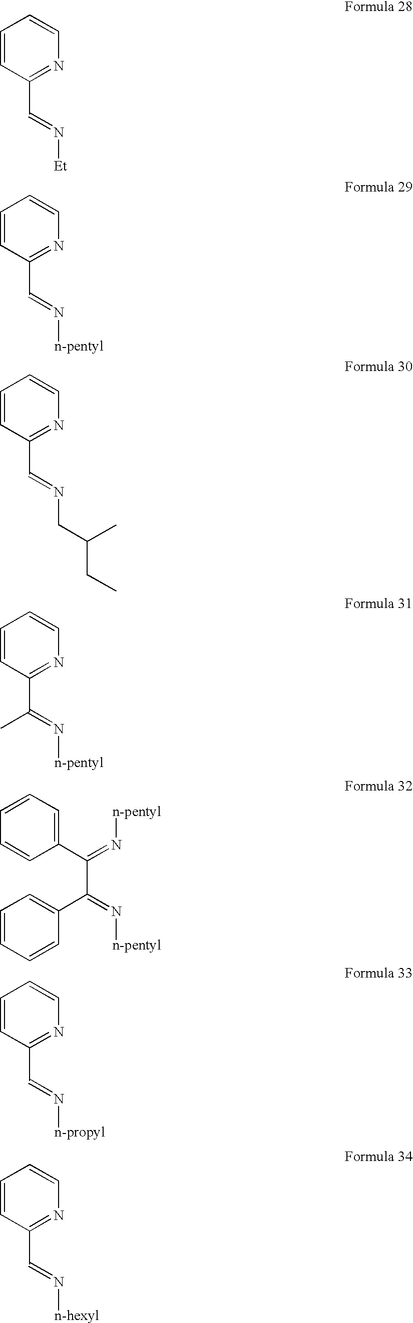 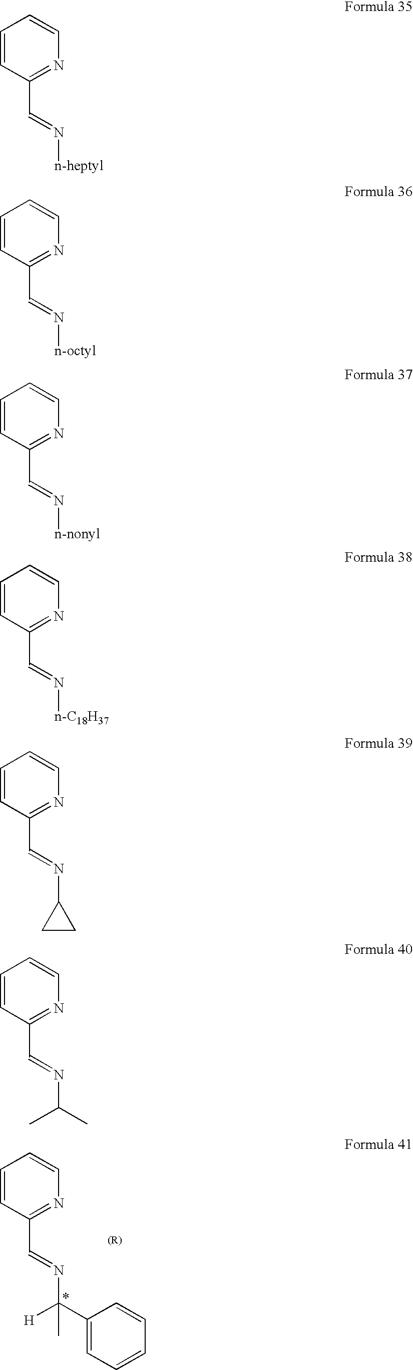 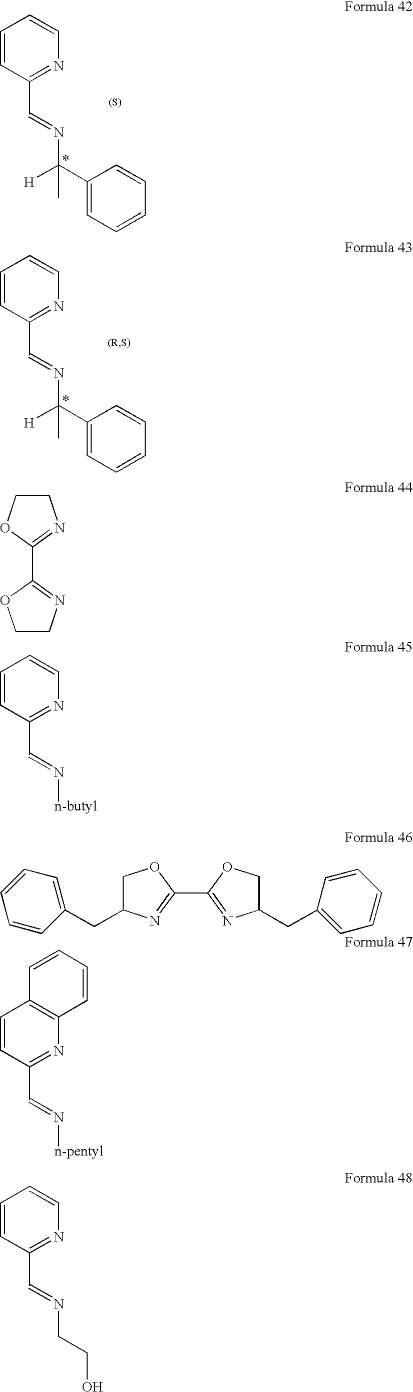 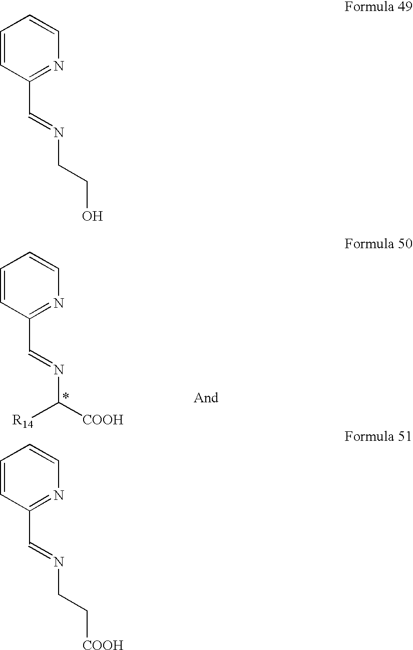
where: *indicates a chiral centre,

R14=Hydrogen, C₁ to C₁₀ branched chain alkyl, carboxy- or hydroxy-C₁ to C₁₀ alkyl.
Preferably the catalyst is 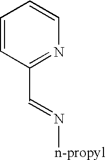
in combination with CuBr.

Preferably the polymerisable monomer used in the process is an olefinically unsaturated monomer. Preferably the monomer is methacrylate, acrylate or styrene. Acrylamide, methacrylamide or acrylonitrile may also be used. Alternative monomers also include dienes such as butadiene, vinylether or vinylacetate.

Examples of olefinically unsaturated monomers that may be polymerised in the method of the invention include methyl methacrylate, ethyl methacrylate, propyl methacrylate (all isomers), butyl methacrylate (all isomers), and other alkyl methacrylates; corresponding acrylates; also functionalised methacrylates and acrylates including glycidyl methacrylate, trimethoxysilyl propyl methacrylate, allyl methacrylate, hydroxyethyl methacrylate, hydroxypropyl methacrylate, dialkylaminoalkyl methacrylates; nitrophenol (meth)acrylates; fluoroalkyl (meth)acrylates; methacrylic acid, acrylic acid; fumaric acid (and esters), itaconic acid (and esters), maleic anhydride; styrene, α-methyl styrene; vinyl halides such as vinyl chloride and vinyl fluoride; acrylonitrile, methacrylonitrile; vinylidene halides of formula CH₂═C(Hal)₂ where each halogen is independently Cl or F; optionally substituted butadienes of the formula CH₂═C(R¹⁵)C(R¹⁵)═CH₂ where R¹⁵ is independently H, C1 to C10 alkyl, Cl, or F; sulphonic acids or derivatives thereof of formula CH₂═CHSO₂OM wherein M is Na, K, Li, N(R¹⁶)₄ where each R¹⁶ is independently H or Cl or alkyl, D is COZ, ON, N(R¹⁶)₂ or SO₂OZ and Z is H, Li, Na, K or N(R¹⁶)₄; acrylamide or derivatives thereof of formula CH₂═CHCON(R¹⁶)₂ and methacrylamide or derivatives thereof of formula CH₂═C(CH₃)CON(R¹⁶)₂. Mixtures of such monomers may be used.

Preferably, the monomers are commercially available and may contain a free-radical inhibitor such as 2,6-di-tert-butyl-4-methylphenol or methoxyphenol.

The invention also provides polymers obtainable by a process according to the invention. Preferably, the polymers comprise at least a portion of the amide initiator attached or incorporated into the polymer. As indicated in Schemes 2 and 3, the initiator separates into the transferable atom or group, and the remainder part of the initiator. The atom or group attaches to one part of the polymer chain, whilst the remaining part of the initiator moiety attaches to another part of the initiator chain. Hence, the part of the initiator attached to the polymer is preferably the amide initiator portion, without its transferable group or atom, but most preferably with its transferable atom or group attached at another part of the polymer.
Preferably, the polymer has a formula selected from: 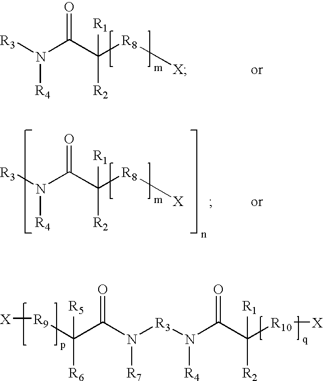
X is selected from Cl, Br, I, OR²⁰, SR²¹, SeR²¹, OP(═O)R²¹, OP(═O)R²¹, OP(═O)(OR²¹)₂, OP(═O)²¹, O—N(R²¹)₂ and S—C(═S)N(R²¹)₂, where R²⁰=a C₁ to C₂₀ alkyl where one or more of the hydrogen atoms may be independently replaced by halide, R²¹ is aryl or a straight or branched C₁-C₂₀ alkyl group, and where an (NR²¹)₂ group is present, the two R²¹ groups may be joined to form a 5- or 6-membered heterocyclic ring; and

R₁, R₂, R₃, R₄, R₅, R₆ and R₇ are each independently selected from H, halogen, C₁-C₂₀ alkyl, C₃-C₈ cycloalkyl, C═YR², C(═Y)NR²³R²⁴, COCl, OH, CN, C₂-C₂₀ alkenyl, C₂-C₂₀ alkynyl, oxiranyl, glycidyl, aryl, heterocyclyl, aralkyl, aralkenyl, C₁-C₆ alkyl in which 1 or more hydrogen atoms are replaced with halogen, substituted or non-substituted C₁ to C₂₀ alkyl interrupted by a disulphide link and C₁ to C₆ alkyl substituted with from 1 to 3 substitutions selected from alkoxyl, aryl, heterocyclyl, C(═Y)R²², C(═Y)NR²³R²⁴, oxiranyl, glycidyl;

where R²² is C₁ to C₂₀ alkyl, C₁ to C₂₀ alkoxy, aryloxy or heterocyclyloxy; and

R²³ and R²⁴ are independently H, C₁ to C₂₀ alkyl, or R²³ and R²⁴ may be joined together to form an alkylene group of 2 to 5 carbon atoms, thus forming a 3- to 6-membered ring;

where Y may be NR²⁵ or O, and R²⁵ is H, straight or branched C₁ to C₂₀ alkyl or aryl;

such that preferably no more than three or no more than two of R₁, R₂, R₃ and R₄ are H, and wherein R₃, R₄ and/or R₇ may additionally be a functional group or a linker attached to a functional group, a polymer and/or a macromolecule; n is an integer of 2 to 100;

and where R₈, R₉ and R₁₀ are selected from methyl methacrylate, ethyl methacrylate, propyl methacrylate (all isomers), butyl methacrylate (all isomers), and other alkyl methacrylates; corresponding acrylates; also functionalised methacrylates and acrylates including glycidyl methacrylate, trimethoxysilyl propyl methacrylate, allyl methacrylate, hydroxyethyl methacrylate, hydroxypropyl methacrylate, dialkylaminoalkyl methacrylates; nitrophenol (meth)acrylates: fluoroalkyl (meth)acrylates; methacrylic acid, acrylic acid; fumaric acid (and esters), itaconic acid (and esters), maleic anhydride; styrene, α-methyl styrene; vinyl halides such as vinyl chloride and vinyl fluoride; acrylonitrile, methacrylonitrile; vinylidene halides of formula CH₂═C(Hal)₂ where each halogen is independently Cl or F; optionally substituted butadienes of the formula CH₂═C(R¹⁵)C(R¹⁵)═CH₂ where R¹⁵ is independently H, C1 to C10 alkyl, Cl, or F; sulphonic acids or derivatives thereof of formula CH₂═CHSO₂OM wherein M is Na, K, Li, N(R¹⁶)₄ where each R¹⁶ is independently H or Cl or alkyl, D is COZ, ON, N(R¹⁶)₂ or SO₂OZ and Z is H, Li, Na, K or N(R¹⁶)₄; or mixtures of such monomers; and m, p and q are independently selectable and are an integer of 1 to 10,000, preferably 1 to 1000, especially 1 to 100; and salts thereof.

The definitions of X, R₁, R₂, R₃ and R₄ are preferably as defined for the first aspect of the invention. R₅ and R₆ may be independently selectable or the same as R₁ and R₂ respectively and may be as defined for R₁ and R₂ in the first aspect of the invention. R₇ may be as defined for R₄ and may be the same as R₄.

R₄ and/or R₇ are preferably H.

Preferably, the polymer has a polydispersity of less than 3, especially less than 2.5, most preferably less than 2 or less than 1.5, most preferably more than 1.1.
Amide initiators having the following formula are also provided:

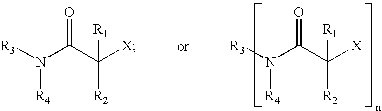

X is selected from Cl, Br, I, OR²⁰, SR²¹, SeR²¹, OP(═O)R²¹, OP(═O)R²¹, OP(═O)(OR²¹)₂, OP(═O)O²¹, O—N(R²¹)₂ and S—C(═S)N(R²¹)₂, where R²⁰=a C₁ to C₂₀ alkyl where one or more of the hydrogen atoms may be independently replaced by halide, R²¹ is aryl or a straight or branched C₁-C₂₀ alkyl group, and where an (NR²¹)₂ group is present, the two R²¹ groups may be joined to form a 5- or 6-membered heterocyclic ring; and

R₁, R₂, R₃ and R₄ are each independently selected from H, halogen, C₁-C₂₀ alkyl, C₃-C₈ cycloalkyl, C═YR²², C(═Y)NR²³R²⁴, COCl, OH, CN, C₂-C₂₀ alkenyl, C₂-C₂₀ alkynyl, oxiranyl, glycidyl, aryl, heterocyclyl, aralkyl, aralkenyl, C₁-C₆ alkyl in which 1 or more hydrogen atoms are replaced with halogen and C₁ to C₆ alkyl substituted with from 1 to 3 substitutions selected from alkoxyl, aryl, heterocyclyl, C(═Y)R²², C(═Y)NR²³R²⁴, oxiranyl glycidyl;

where R²² is C₁ to C₂₀ alkyl, C₁ to C₂₀ alkoxy, aryloxy or heterocyclyloxy; and

R²³ and R²⁴ are independently H, C₁ to C₂₀ alkyl, or R²³ and R²⁴ may be joined together to form an alkylene group of 2 to 5 carbon atoms, thus forming a 3- to 6-membered ring;

where Y may be NR²⁵ or O, and R²⁵ is H, straight or branched C₁ to C₂₀ alkyl or aryl;

such that preferably more than three or no more than two of R₁, R₂, R₃ and R₄ are H, and wherein R₃ and/or R₄ may additionally be a functional group or a linker attached to a functional group, a polymer and/or a macromolecule; n is an integer of 2 to 100 (preferably 2, 3 or 4); and salts thereof.

Preferably X, R₁, R₂, R₃ and R₄ are as defined for the first aspect of the invention.

Preferably, the initiator used, according to any aspect of the invention, is not N,N-dimethyl-2-chloropropionamide, comprise a silicone surface, or is not bromo-2-methyl-propionamide except for N-benzyl-2-bromo-2-methyl-propionamides which advantageously are UV/V spectroscopy visible.

Preferably, the amide initiator, according to any aspect of the invention, is N-bensyl-2-bromo-2-methyl-propionamide, L-alanine-methylester-2-bromo-2-methyl-propionamide, or a difunctional bromoamide poly(dimethylsiloxane).
Preferably the initiator is selected from 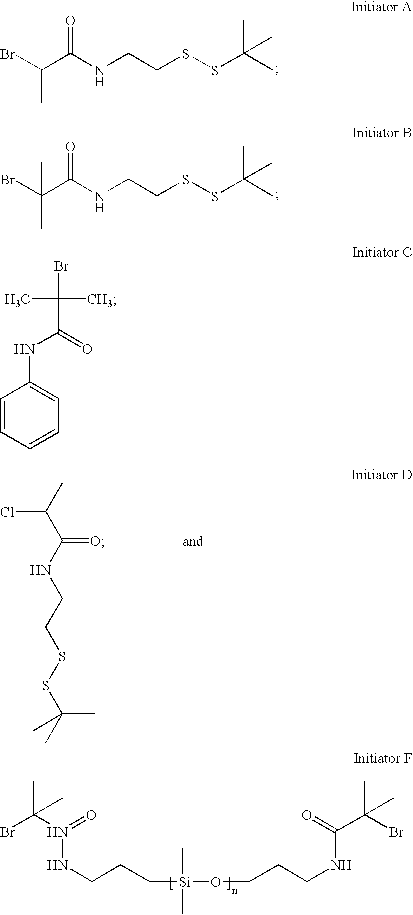
Experimental
General Characterisation

¹H (300 MHz) and ¹³C (100 MHz)NMR spectra were recorded on a Bruker DPX300 spectrometer using deuterated solvents from Aldrich. Infra-red spectra were recorded on a Bruker Vector 22 FTIR spectrometer using a Golden Gate attenuated total reflection (ATR) cell. Elemental analysis was conducted using a Leeman Labs CE400 elemental analyser.

Size exclusion chromatography (SEC) was carried out using a Polymer Laboratories modular system equipped with a differential refractive index (DRI) and UV/VIS detectors calibrated with linear poly(methyl methacrylate) standards (Mₚ=200 to 1.577×10⁶ g mol⁻¹) and linear poly(styrene) standards (Mₚ=540 to 1.640×10⁶ g mol⁻¹). The mobile phase used was 95% tetrahydrofuran (THF), 5% triethylamine and the elution time was standardised against that of toluene. The flow rate was set at 1.0 mL/min. The system was equipped with a PL-gel 5 μm (50×7.5 mm) guard column and two PL-gel 5 μm (300×7.5 mm) mixed C (suitable for separations up to M_{w} 2,000,000 g mol⁻¹) columns thermostated at 25° C.

Materials

Methyl methacrylate (Aldrich; 99%), butyl methacrylate (BMA) (Aldrich; 99%) benzyl methacrylate (BzMA) (Aldrich; 96%) and styrene (Lancaster; 99%) were purified by passage through a short column of activated basic alumina before use to remove inhibitors and acidic impurities. This was deoxygenated by purging with dry nitrogen gas for approximately 30 minutes prior to being stored at 0° C. (Dimethylamino)ethyl methacrylate (DMAEMA) (Aldrich; 98%) was bubbled with dry nitrogen gas for 30 minutes prior to use. Toluene (BDH, 98%) was degassed by bubbling with nitrogen for thirty minutes and stored in a sealed flask under nitrogen. Copper(I) bromide (Aldrich; 99%) and copper(I) chloride (Aldrich; 98%) were purified according to the method of Keller and Wycoff.⁴¹ Benzyl Amine (Aldrich; 99%), triethylamine (Aldrich; 99.5%), 2-bromoisobutyryl bromide (Aldrich; 98%), L-alanine methyl ester (Fluka; 99%), aminopropyl terminated poly(dimethyl siloxane) (ABCR) and D8-Methyl Methacrylate (Aldrich; 99%) were used as received. Diimine ligands were prepared as described previously.⁴² All other materials were obtained from Aldrich and were used without any further purification unless otherwise stated. 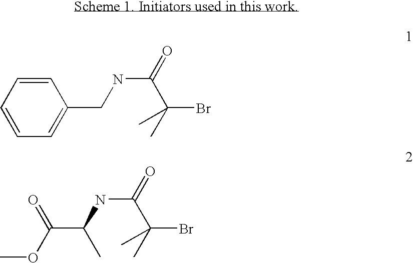
Synthesis of N-benzyl-2-bromo-2-methyl-propionamide, 1, scheme 1.

Benzyl amine (30 mL, 0.27 mol), triethylamine (76.5 mL, 0.55 mol), and anhydrous THF (1000 mL) were placed in a three-neck round-bottomed flask. 2-bromoisobutyryl bromide (50.9 mL, 0.41 mol) was added slowly at 0° C. with stirring. A white precipitate, of triethylammonium bromide, was formed, and the reaction was left for 20 h at ambient temperature with stirring. The precipitate was removed by filtration prior to removal of volatiles in vacuo to leave a brown liquid. The product was re-dissolved in dichloromethane and was subsequently isolated following washing with two 200 mL portions of saturated sodium carbonate solution, 0.5 molar HCl(aq), and deionized water. The dichloromethane solution was dried over MgSO₄ and the volatiles removed in vacuo to give a light brown solid.

¹H NMR (CDCl₃, 298 K, 300 MHz) δ 7.31 (M, 5H, Aro), 7.02 (S, 1H, NH), 4.46 (d, J=5.8 Hz, 2H, Aro-CH₂—NH), 1.99 (s, 6H, C═O—CMe₂).

¹³C NMR (CDCl₃, 298 K, 100.6 MHz) δ 171.95 (C═O), 137.77, 128.81, 127.55, 127.40 (Aro), 62.90 (C═O—CMe₂), 44.38 (Aro-CH₂—NH), 32.62 (C═O—CMe₂). (cm? IR (solid, ATR cell)μ⁻¹) 3291 (amide N—H stretch), 1642 (amide —CONH stretch), 1534 (aro —H vibration), 1354, 1293, 1102, 693, 638.

CHN Analysis; calculated, C=51.58%, H=5.51%, N=5.47%: Found, C=51.39%, H=5.48%, N=5.51%

Synthesis of L-Alanine-methylester-2-bromo-2-methyl-propionamide, 2, Scheme 1.

L-Alanine methyl ester (19.5 g, 0.14 mol), triethylamine (76.5 mL, 0.51 mol), and anhydrous dichloromethane (700 mL) were placed in a three-neck round-bottomed flask. 2-Bromoisobutyryl bromide (36.5 mL, 0.30 mol) was added slowly at 0° C. with stirring. A white precipitate, of triethylammonium bromide, was formed, and the reaction was left for 20 h at ambient temperature with stirring. The precipitate was removed by filtration prior to removal of volatiles in vacuo to leave a brown liquid. The product was re-dissolved in dichloromethane and was subsequently isolated following washing with two 200 mL portions of saturated sodium carbonate solution, 0.5 molar HCl(aq), and deionized water. The dichloromethane solution was dried over MgSO₄ and the volatiles removed in vacuo to give an orange liquid. Yield=82.4%

¹H NMR (CDCl₃, 298 K) δ 7.20 (S, 1H, NH), 4.52 (m, 1H, C═OCHCH₃NH), 3.77 (s, 3H, C═O—OMe), 1.96 (s, 6H, C═O—CMe₂), 1.45 (d, J=7.3 Hz, 3H, C═OCHCH₃NH).

¹³C NMR (CDCl₃, 298 K) δ 172.95 (C═O—OMe), 171.57 (C═O—NH), 61.77 (C═O—CMe₂), 52.51 (O—CH₃), 48.87 (C═OCHCH₃NH), 32.27 (C═O—CMe₇), 17.98 (C═OCHCH₃NH).

CHN Analysis; calculated, C=38.11%, H=5.60%, N=5.56%: Found, C=38.02%, H=5.57%, N=5.58%.

Preparation of Di-Functional α-Bromoamide Poly(Dimethylsiloxane) macroinitiator

Aminopropyl terminated poly(dimethyl siloxane) with a molecular weight of approximately 5000 g mol⁻¹ (PDI=1.65 as determined by ourselves using SEC calibrated with PMMA standards) was used. Aminopropyl terminated PDMS (30 g, 6 mmol), triethylamine (4 mL, 28 mmol), and anhydrous tetrahydrofuran (300 mL) were placed in a three-neck round-bottomed flask. 2-Bromoisobutyryl bromide (2.6 mL, 20 mmol) was added slowly at 0° C. with stirring. A white precipitate, of triethylammonium bromide, was formed, and the reaction was left for 20 h at ambient temperature with continued stirring. The precipitate was removed by filtration prior to removal of volatiles in vacuo to leave a brown oil. The product was re-dissolved in dichloromethane and was subsequently isolated following washing with two 200 mL portions of saturated sodium carbonate solution, 0.5 molar HCl(aq), and deionized water. The dichloromethane solution was dried over MgSO₄ and the volatiles removed in vacuo to give an orange oil.

¹H NMR (CDCl₃ 298 K): δ (ppm): 6.78 (s, 1H, NH), 3.22 (t, J=7.2, 2H, CH₂NH), 1.97 (s, 6H, C(CH₃)₂Br), 1.55 (m, 2H, CH₂CH₂CH₂), 0.53 (m, 2H, CH₂SiO), 0.06 (s, 6H, nSi(CH₃)₂).

¹³ C NMR (CDCl₃, 298 K) δ (ppm)=176.0 (C═O), 62.0 (NH—CH₂), 56.1 NH—CH₂CH₂), 43.7 (CH₂—Si), 44.9 (CBr(CH₃)₂), 31.2 (C(CH₃)₂Br), 0.1 (Si(CH₃)₂)ₙ, (n=40).

IR absorption v (cm⁻¹) 2963 (alkyl C—H stretch), 1670 (amide —CONH stretch), 1260 (—Si(CH₃)₂) and 1095-1025 (Si—O).

Polymerization of Methyl Methacrylate (MMA)

Methyl methacrylate was polymerised with both 1 and 2 as initiators, Cu(I)Cl and N-n-octyl-2-pyridylmethanimine as catalyst. Typically, Cu(I)Cl (0.138 g, 1.39×10⁻³ mol) and 1 (0.356 g, 1.39×10⁻³ mol), was added to a Schlenk tube which was fitted with a rubber septum and pump-filled with nitrogen three times. Subsequently deoxygenated and inhibitor-free MMA (15 mL, 0.14 mol), deoxygenated toluene (15 mL) and N-n-octyl-2-pyridylmethanimine (0.67 mL, 2.9×10⁻³ mol) were added to the Schlenk tube under nitrogen. The solution was further deoxygenated by three freeze-pump-thaw cycles before being heated to 25° C. for thirty minutes. The solution was subsequently heated to 90° C. Samples were removed periodically for conversion and GPC analysis via syringe. The final polymer was purified by the passage of the solution over a basic alumina column and was isolated by precipitation in cold petroleum ether (40-60) and drying in vacuo. Mₙ=48,200 g mol⁻¹ (PDI=1.18) in 87.9% conversion after 4.5 hours.

Polymerization of Styrene

Styrene was polymerised with both 1 and 2 as initiators, Cu(I)Br and N-n-octyl-2-pyridylmethanimine as catalyst. Typically, Cu(I)Br (0.227 g, 1.58×10⁻³ mol) and 1 (0.404 g, 1.58×10⁻³ mol), were added to a Schlenk tube that was fitted with a rubber septum and pump-filled with nitrogen three times. The mixture was subsequently deoxygenated and inhibitor-free styrene (15 mL, 0.16 mol), deoxygenated toluene (15 mL) and N-n-octyl-2-pyridylmethanimine (0.76 mL, 3.2×10⁻³ mol) were added to the Schlenk tube under nitrogen. The solution was further deoxygenated by three freeze-pump-thaw cycles before being heated to 25° C. for thirty minutes. The solution was heated to 110° C. Samples were removed periodically for conversion and GPC analysis via syringe. The final polymer was purified by the passage of the solution over a basic alumina column and was isolated by precipitation in cold methanol and drying in vacuo. Mₙ of 6,800, polydispersity=1.24 and 65% conversion in 12 hours.

Preparation of PMMA-PDMAEMA Block Copolymer

Cu(I)Br (0.024 g, 1.67×10⁻⁴ mol) and PMMA (polymethylmethacrylate) (2 g, 1.67×10⁻⁴ mol) were added to a Schlenk tube that was fitted with a rubber septum and pump-filled with nitrogen three times. Subsequently deoxygenated DMAEMA (dimethyl aminoethylmethacrylate) (5.85 mL, 0.034 mol), deoxygenated toluene (20 mL) and N-n-propyl-2-pyridylmethanimine (0.056 mL, 3.7×10⁻⁴ mol) were added to the Schlenk tube under nitrogen. The solution was further degassed by three freeze-pump-thaw cycles before being heated to 25° C. for 20 hours. Samples were removed periodically for conversion and GPC analysis via syringe. The final polymer was purified by the passage of the solution over a basic alumina column and was isolated by precipitation in cold petroleum ether (40-60) and drying in vacuo. Mₙ=11,500, polydispersity=1.18 (SEC).

Preparation of PMMA-PDMS-PMMA Triblock Copolymer

Cu(I)Cl(0.158 g, 1.59×10⁻³ mol) and PDMS (polydimethylsiloxane) initiator (4 g, 8×10⁻⁴ mol) were added to a Schlenk tube that was fitted with a rubber septum and pump-filled with nitrogen three times. Subsequently deoxygenated and inhibitor-free MMA (17.16 mL, 0.16 mol), deoxygenated toluene (20 mL) and N-n-octyl-2-pyridylmethanimine (0.76 mL, 3.2×10⁻³ mol) were added to the Schlenk tube under nitrogen. The solution was further deoxygenated by three freeze-pump-thaw cycles before being heated to 25° C. for thirty minutes. The solution was subsequently heated to 90° C. Samples were removed periodically for conversion and GPC analysis via syringe. The final polymer was purified by the passage of the solution over a basic alumina column and was isolated by drying in vacuo. Mₙ=29,600 g mol⁻¹, polydispersity=1.27.

Results and Discussion

Preparation of Poly(Methacrylates)

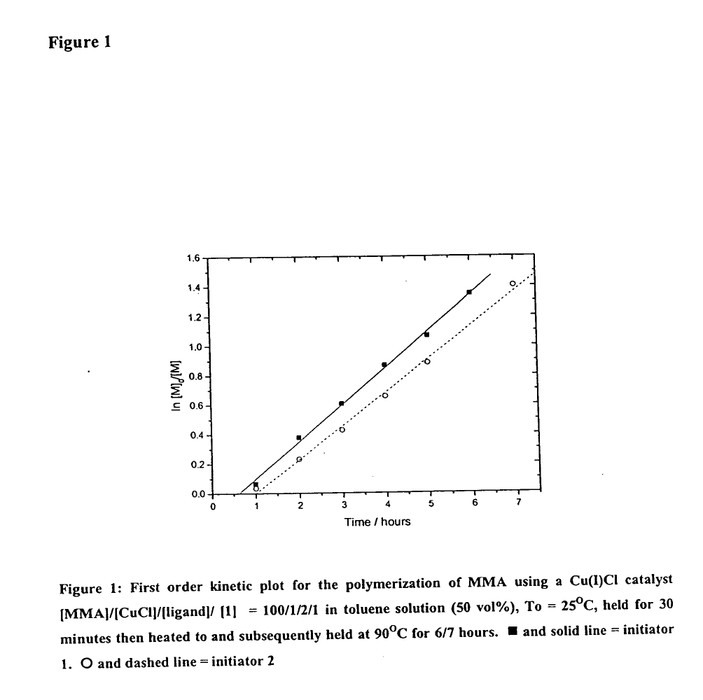

The polymerization of MMA was investigated under a range of reaction conditions, scheme 2. The nature of the catalyst and the reaction temperature were varied. All reactions were conducted in toluene (50% v/v) with a target theoretical molecular weight of 10,000 g mol⁻¹ ([MMA]:[Initiator]=100), with 1 as initiator. When Cu(I)Br was used to form the catalyst and the reaction was carried out by rapid heating to 90° C. at the start of the reaction gave PMMA with Mₙ=48,200 g mol⁻¹ (PDI=1.18) in 87.9% conversion after 4.5 hours. When the reaction was started at 25° C. and held at this temperature for thirty minutes prior to slow heating to 90° C. the resulting PMMA had Mₙ=45,700 g mol⁻¹ (PDI=1.18) in 90% conversion after three hours. When the reaction was catalysed by Cu(I)Cl a conversion of 33.5%, with Mₙ=26,600 g mol⁻¹ (PDI=1.13) was obtained, again significantly greater then the predicted value. When the polymerization was carried out with Cu(I)Cl with the initial 30 minutes of the reaction at 25° C., followed by slowly heating (over 15 minutes) to 90° C., 79% conversion was achieved in 6 hours; Mₙ=10,700 g mol⁻¹ (PDI=1.23), the polymerization data is summarized in Table 1. FIG. 1 shows the kinetic plot for the Cu(I)Cl mediated polymerization of MMA with Tₒ=25° C. and

TABLE 1
Polymerization data for the polymerization of MMA with
CuX/N-n-octyl-2-pyridylmethanimine (1:2) as catalyst with
1 as initiator in toluene solution (33 vol %);

| | | | Mₙ | | | Time |
|---|---|---|---|---|---|---|
| Catalyst | Tₒ^{a} | Mₙ₍ₜₕₑₒ₎^{b} | g mol⁻¹ | PDI | Conversion^{c} % | Hrs |
| CuBr | 90 | 8800 | 48 200 | 1.18 | 88 | 4.5 |
| CuBr | 25 | 9000 | 45 700 | 1.18 | 90 | 3 |
| CuCl | 90 | 3300 | 26 600 | 1.13 | 33 | 10.5 |
| CuCl | 25 | 7900 | 10 700 | 1.23 | 79 | 6 |

^{a}where Tₒ = 25° C. reaction held at 25° C. for 30 minutes prior to heating to 90° C. over 15 minutes;
^{b}Mₙ₍ₜₕₑₒ₎ = [MMA]/[1] (100) * Mₒ (100) * % conversion;
^{c}conversion from ¹H NMR.

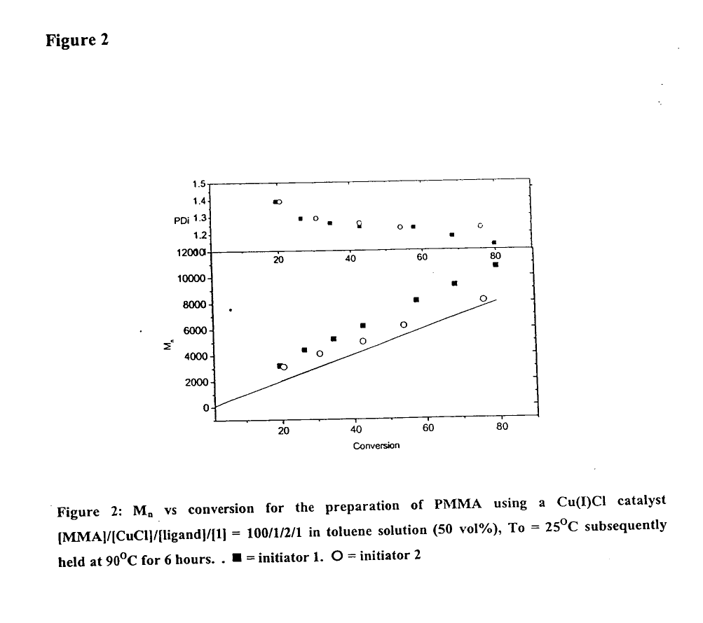

FIG. 2 shows the increase of Mₙ with conversion. In FIG. 1 an induction period is observed at the start of the reaction which is due to the 30 minute period at 25° C. and the time taken to heat the oil bath to reaction temperature. Under these conditions the polymerization shows characteristics of a living polymerization resulting in polymer with controlled molecular weight and narrow PDI, which narrows on increasing conversion as expected.

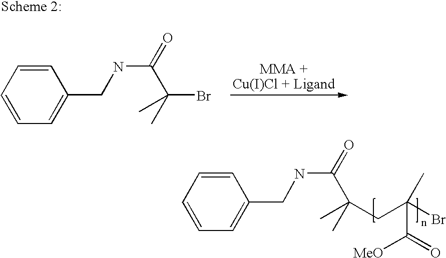

Polymerization of MMA with an initiator derived from L-alanine, 2, with Cu(I)Cl catalyst gave polymers of with Mₙ close to the theoretical value, assuming each initiator starts one polymer chain, with low polydispersity. This polymerization was started at 25° C. and held at this temperature for thirty minutes prior to slowly raising to 90° C. A conversion of 58% was achieved in seven hours with Mₙ=8100 g mol⁻¹ (PDi=1.23) (M_{nTheo}=5900 g mol⁻¹). Thus when CuCl is used with bromo-2-methyl-propionamide based initiators and the reaction mixture is allowed to react for 30 minutes at ambient temperature prior to slow heating to reaction temperature living polymerization ensues and the previous observations confirm the conditions that are ideally suited for copper mediated polymerization of methacrylates. With amide initiators the initial initiation step likely occurs rapidly leading to a high concentration of free radicals, which results in radical-radical coupling/disproportionation in competition with initiation/propagation. A low temperature at the start of the reaction to 25° C. still allows initiation to proceed but more slowly 43. The use of Cu(I)Cl as opposed to Cu(I)Br also reduces the rate of homolytic bond fission 44. Following initiation, the halogen is alpha to an ester as is normal in this type of polymerization and reaction proceeds more efficiently at higher temperature resulting in living polymerization.

A range of methacrylate monomers were polymerized, butyl methacrylate, benzyl methacrylate (BzMA), dimethylaminoethyl methacrylate (DMAEMA) and poly(ethylene glycol)methyl ether methacrylate (PEGMA), using Cu(I)Cl and N-benzyl-2-bromo-2-methyl-propionamide to verify the versatility of the polymerization system. All reactions were started at 25° C. and held at this temperature for 30 minutes prior to increasing the temperature slowly to 90° C., Table 2. Although in some cases there is significant difference between the theoretical and SEC values (it is noted that the SEC was calibrated with linear PMMA standards) the Mₙ values determined by NMR agree well with the theoretical values. In the case of BMA the initiator efficiency can be calculate at each conversion point and was found to vary between 0.58 and 0.74 throughout the reaction. The Mₙ from ¹H NMR was calculated using the aromatic signals of the initiating end group (δ7.31 and 7.02) and the polymer backbone CH₂—CH₂CH₃ signals at δ1.2 to 0.8. The differences between the SEC molecular weights and the theoretical Mₙ are in part due to calibration errors associated with calibrating the SEC with PMMA however, we are reassured by the good agreement with the NMR Mₙ values which could only be measured at the end of the reaction.

TABLE 2
Molecular mass data for the polymerization of methacrylates with 1 in the
presence of Cu(I)Cl, [ligand]/[1]/[ligand]/[CuCl] (for ratios,
conversion, molecular weight and NMR date see supplementary
information) in toluene solution 50%.

| | M_{n,Theo} | M_{n,NMR} | M_{n,SEC} | |
|---|---|---|---|---|
| Monomer | g mol⁻¹ | g mol⁻¹ | g mol⁻¹ | PDi |
| MMA | 8,000 | 10,400 | 10,700 | 1.13 |
| BMA | 7,000 | 8,700 | 13,000 | 1.27 |
| BzMA | 9,700 | 11,400 | 17,200 | 1.25 |
| DMAEMA | 8,100 | 10,900 | 21,100 | 1.24 |
| PEGMA 300 | 6,500 | 8,100 | 12,900 | 1.24 |

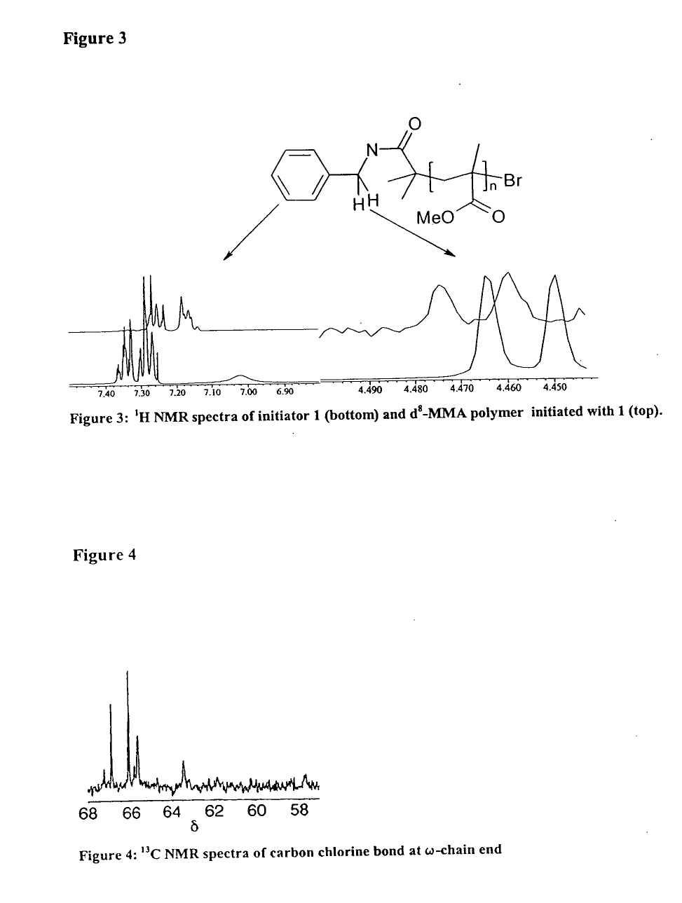

Polymerization of d⁸-MMA allowed the nature and the presence of the initiator in the final polymer to be observed more clearly than with protonated MMA due to the absence of peaks from the repeat unit, FIG. 3. Three resonances from the initiator can be seen in both spectra with a shift in chemical shift as a C—Br bond is replaced with a C—C bond. FIG. 3 shows the shifts for the benzene ring which have shifted 0.1 ppm (δ7.22 to 7.33) and also the CH₂ group between the benzene ring and the amide group. The signal for the amide group (δ7.03) itself has also disappeared in the polymer spectra. ¹³C NMR spectroscopy confirmed the presence of a carbon chlorine bond at the ω-chain end, δ67.1 and 66.3, FIG. 4, and also the presence of the initiator at the α-chain end. Thus polymers have both alpha and omega termini derived from the initiator as would be expected for an analogous ester derived initiator.

Polymerization of Styrene

The polymerization of styrene was also investigated under a range of conditions. All reactions were conducted in toluene (50% v/v) with a target molecular weight of 9,000 g mol⁻¹ with 1 as initiator. Firstly a polymerization was conducted using Cu(I)Br as catalyst with the reaction started with all of the reagents heated to 90° C. A second polymerization was carried out using Cu(I)Br in which the reaction was started at 25° C. and held at this temperature for thirty minutes prior to raising to 90° C. The experiments were repeated using Cu(I)Cl as catalyst. The products of the reactions started at 90° C. had molecular weights similar to the predicted values. The reaction catalyzed by Cu(I)Br achieved 65% conversion in 12 hours; Mₙ=6,800, polydispersity=1.24. The reaction catalyzed by Cu(I)Cl achieved a conversion of 80% in 24 hours; Mₙ of 7,600, polydispersity=1.56. The polymerizations started at 25° C. exhibited similar results. The polymerization conducted using Cu(I)Br achieved 62% conversion in twelve hours; the resulting polymer had an Mₙ=7,900 with polydispersity=1.24. When the same polymerization was repeated using Cu(I)Cl, 76% conversion was achieved in 24 hours. The resulting polymer had an Mₙ of 7,400 and a polydispersity=1.46. These results are in contrast to the observations made with methacrylate monomers with Cu(I)Br mediated polymerizations yielding better results than those catalysed by Cu(I)Cl. It also appears that starting the reaction at a lower temperature has no benefit in this case. This may be explained be the slower rate of polymerization of styrene compared to MMA, due to the creation of a secondary radical in styrene, which is stabilized by the aromatic ring. Styrene was also polymerised with L-alanine-methylester-2-bromo-2-methyl-propionamide as initiator. The reaction was catalyzed with Cu(I)Br and started at 90° C. The polymerization achieved 72% conversion in 12 hours; analysis of the final product showed Mₙ of 5,800 with a polydispersity=1.27.

Preparation of Block Copolymers

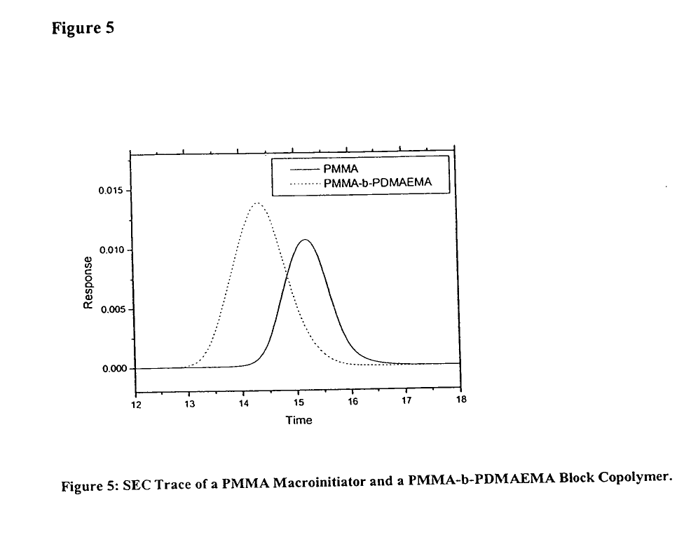

To further investigate the living characteristics of polymers prepared from N-benzyl-2-bromo-2-methyl-propionamide initiator, a block copolymer was prepared via sequential addition. Initially a homopolymer block of MMA was prepared using Cu(I)Cl as catalyst. The reaction was commenced at 25° C. and held at this temperature for thirty minutes prior to heating to 90° C. The isolated and purified polymer had Mⁿ=11,500 with polydispersity=1.18 (SEC). This polymer was subsequently used as a macroinitiator for the polymerization of DMAEMA at 100° C. using Cu(I)Br as catalyst. The resulting block copolymer had Mₙ=34,700 and a polydispersity=1.25 (SEC). FIG. 5 shows the SEC traces of the PMMA macroinitiator and the resulting PMMA-b-PDMAEMA block copolymer, confirming the formation of a block copolymer. 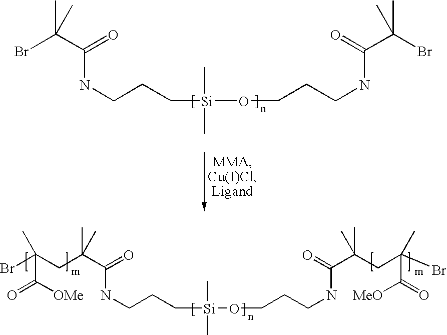
Scheme 3:

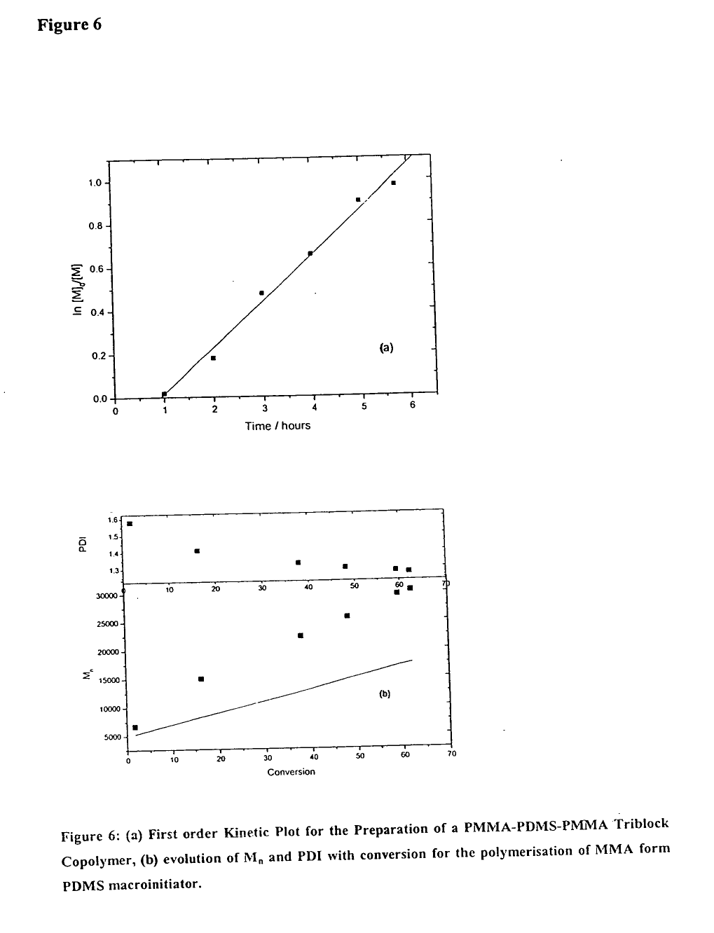

To demonstrate further the robust nature of this polymerization technique, an ABA triblock copolymer was prepared from a di-aminopropyl functional poly(dimethylsiloxane) (PDMS) di-functional macroinitiator prepared from the reaction of di-aminopropyl terminated PDMS with 2-bromoisobutyryl bromide, scheme 3. Subsequent polymerization of MMA, Cu(I)Cl catalyst with an initial temperature of 25° C. and subsequently slow heating to 90° C. led to 62% conversion after 5.75 hours (Mₙ₌29,600 g mol⁻¹ polydispersity=1.27 (SEC)). ¹H NMR spectroscopy indicated and Mⁿ=13,100 g mol⁻¹ in good agreement with the theoretical value of 11,200 g mol⁻¹. FIG. 6 shows the linear first order kinetic plot for the preparation of an ABA PMMA-PDMS-PMMA triblock copolymer. In FIG. 6 an induction period is observed at the start of the reaction which corresponds to the 30 minute period at 25° C. and the time taken to heat the oil bath to reaction temperature. Further analysis by SEC indicates that molecular weight increases with conversion and polydispersity is reduced with increasing conversion.

Conclusions

We have shown that under the appropriate reaction conditions, amide functional initiators based on bromo-2-methyl-propionamide can be successfully used to prepare a range of poly(methacrylate)s and polystyrene under living radical conditions with Mₙ approximately equal to [Monomer]/[Init]*Mₒ with narrow polydispersity. In the case of methacrylates it is important to reduce the rate of the initiation step in which the halogen alpha to an amide is being transferred to monomer. Following this subsequent propagation steps involve the halide alpha to an ester group. Thus propagation can be carried out under more conventional reaction conditions. The reduction in rate can also be achieved in part by the use of CuCl in place of CuBr. Block copolymers were also prepared to further demonstrate the robustness of these initiators. It has been accepted for a considerable period of time that many species containing hydroxyl functionality can be transformed into LRP initiators by appropriate esterification. The present results show that this is also true for amines following a relatively straightforward amidation. As amides are more hydrolytically stable than esters, especially in the presence of esterases, this not only increases the range of molecules that may be utilized as initiators but also results in a more stable chemical bond between the chain and the chain terminus.

Disulphide and Benzylamide α-Functional Initiators

The aim of this study was to produce a series of disulphide alpha functional N-hydroxysuccinimide methacrylate polymers with an amide linkage between the end group and the active polymer, and the polymer having narrow polydispersity (<1.2).

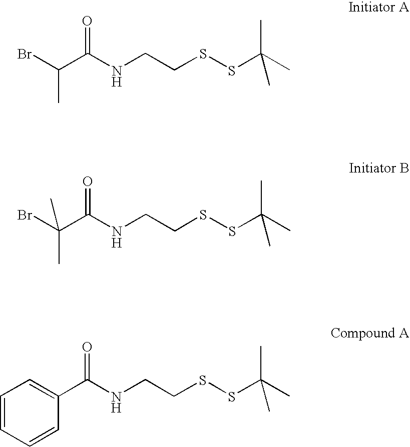

Primary studies focused on the addition of Compound A to a standard transition metal mediated living radical polymerisation (TMM-LRP) reaction of methyl methacrylate (MMA) to establish if the disulphide linkage had any adverse effect. The reaction with ethyl 2-isobutyrate and an initiator proceeded as expected with linear kinetics and the resultant polymer having a narrow polydispersity and molecular weight consistent with the theoretical value obtained from conversion.

Standard polymerisations of MMA were carried out where initiators A & B were substituted for the standard initiator with no pre-incubation step. These reactions were repeatedly unsuccessful with no polymerisation detectable even after 48 hours; 42 hours longer than a reaction using a standard initiator takes to reach completion. The presence of the amide group reduces the strength of the carbon halide bond in the initiator, the balance of which is essential to TMM-LRP. It was hypothesised that by placing the prepared reaction solutions into a pre-heated oil bath it would cause rapid degradation of the initiator causing immediate termination, yielding no polymer. It was considered that initiation would take place at a much lower temperature than the propagation step and therefore reactions were repeated with reaction solutions being placed in a cold oil bath which was subsequently heated to the reaction temperature of 90° C. These reactions yielded polymer with Mn 36,500 at 22% conversion) and had relatively high polydispersities (1.4+). The reactions were repeated with copper chloride instead of copper bromide and these reactions gave much better results though conversions were fairly low at around 20%.

Further work was carried out using N-hydroxy succinimide methacrylate (NHSMA) in DMSO. A number of reactions were carried out with initiators A & B varying several factors; reaction temperature (40, 50, 60, 70, 90, 100 & 110), copper halide (either bromide or chloride), addition of copper(II) halides to decrease the rate of initiation, lowered concentration of Cu(I) to reduce the rate of initiation, additives to increase the rate of propagation (methanol, phenol and tested N-methylpyrolidone instead of DMSO). The method was also altered as it was discovered that methacrylates spontaneously polymerise in DMSO in the presence of copper halides.

The use of a benzylamide based initiator for the polymerisation of methyl methacrylate (Initiator C, below) has been used by the applicants. They attempted to polymerise NHSMA using this initiator however no polymer was formed without prior incubation. They also tried to polymerise nitrophenol methacrylate as an alternative reactive monomer to no avail.

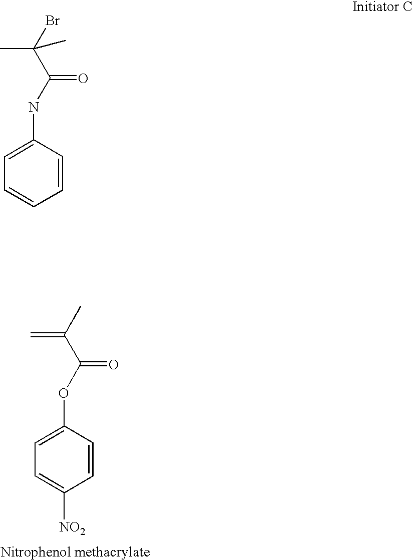

As discussed the strength of the carbon halide bond in the initiator molecule is essential for a controlled polymerisation, therefore Celltech supplied a chlorine version of one of the previous initiators, Initiator D was tried.

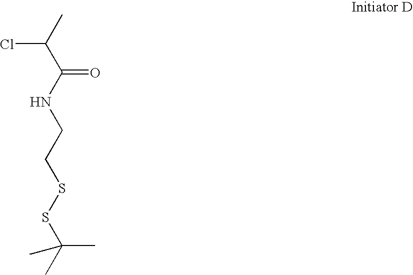

Again a series of polymerisations were carried out with this new initiator at different temperatures. At low temperatures there was no polymerisation, but prior incubation at room temperature followed by reaction at 90° C. resulted in polymerisation and yields rose to around 50% after 48 hours (Mn˜50,000) and high polydispersity (≈2+).
Preliminary Studies were Carried Out Using the Two Model Initiators Below:

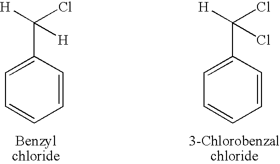

When these initiators were substituted into the standard TMM-LRP reaction conditions used for NHSMA in place of the typical ethyl-2-bromoisobutyrate the results were positive. The reactions proceeded to give good yields with molecular weights increasing as would be expected with conversion. The two compounds gave relatively different polydispersities. Polymers made using benzyl chloride having PDI's around 1.7 and up, whilst those made using 3-chlorobenzal chloride gave better results with PDI's below 1.5. A series of polymerisations using the 3-Chlorobenzal chloride were carried out at different temperatures with either copper chloride or copper bromide to find optimum conditions. A disulphide functional version of the 3-chlorobenzal chloride, initiator E, was tested using the optimum conditions for 3-chlorobenzal chloride to give reasonable results.

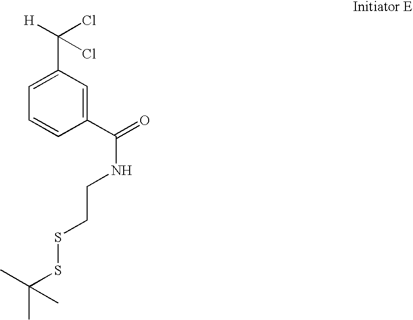

A series of reactions were carried out with initiator E (a comparative example) to optimise the conditions further, the final reaction conditions are discussed in the experimental section. A final set of polymerisations were carried out to make the desired molecular weight polymers having DP's of 25, 50, 100 and 200. The experimental conditions and results of these six polymerisations are tabulated below:

Experimental data for polymerisations in dimethylsulphoxide
(67% V/Wt) [Cu(I)Cl]/[N-n-propylpyridylmethanimine]/[Initiator E]
ratio of 1:2:1 at 100° C.

| | Time | | | | |
|---|---|---|---|---|---|
| Target DP | (Mins) | Conversion | DP | Mn | PDI |
| 15 | 40 | 67% | 17 | 3,100 | 1.19 |
| 40 | 50 | 66% | 24 | 4,400 | 1.31 |
| 50 | 60 | 78% | 100 | 18,200 | 1.19 |
| 100 | 60 | 69% | 110 | 20,100 | 1.20 |
| 150 | 60 | 72% | 175 | 31,900 | 1.34 |
| 300 | 120 | 64% | 195 | 35,650 | 1.31 |

The best reaction conditions were found using the 3-chlorobenzylchloride based initiator (initiator E), using Cu(I)Cl at 100° C. to give polymers with polydispersity indexes of between 1.2 to 1.3.

Experimental

Polymerisation Procedure

Typical Synthesis:

Reactions were carried out in Schlenk tubes sealed with rubber septa. Cu(I)Cl (0.54 g, 5.46×10⁻³ mol) was added to the reaction vessel and subsequently deoxygenated by three consecutive vacuum, nitrogen purge cycles. To a second Schlenk tube initiator, such as Initiator E (1.92 g, 5.46×10⁻² mol), N-hydroxy succinimide methacrylate (15.0 g, 0.082 mol), mesitylene (3.0 mL) and dimethyl sulphoxide (30 mL) were added and the mixture deoxygenated by purging with nitrogen for 30 minutes. Mesitylene is present as a standard marker to enable conversion calculations from ¹H NMR. Once the solution was fully degassed N-(n-Propyl)-2-pyridylmethanimine (1.70 mL, 1.09×10⁻² mol) was added by pre-dried gas tight syringe to the Schlenk tube containing the copper chloride. The solution in the second Schlenk was then added to the catalyst containing Schlenk via a nitrogen purged stainless steel canular and, unless pre-incubation at a low temperature is required, the reaction mixture immediately placed in to a pre-heated oil bath set at 100° C. Samples were taken using deoxygenated gas tight syringe and immediately quenched by freezing in liquid nitrogen. The reaction was terminated by cooling rapidly and subsequent exposure to air. Polymers were purified by multiple precipitations from acetone using copious amounts of acetone to wash away dimethyl sulphoxide.

Initiator B, N-Hydroxysuccinimide Methacrylate, DMSO, No Pre-Incubation

Cu(I)Br (0.039 g, 2.72×10⁻⁴ mol), N-hydroxy succinimide methacrylate (5.0 g, 0.027 mol), Initiator B (0.086 g, 2.72×10⁻⁴ mol) and dimethylsulphoxide (10 mL) were added to a Schlenk tube sealed with a rubber septa and subsequently deoxygenated by three consecutive freeze, vacuum, nitrogen purge cycles. Once the solution was fully degassed N-(n-Propyl)-2-pyridylmethanimine (0.085 mL, 5.46×10⁻⁴ mol) was added by pre-dried gas tight syringe to the Schlenk tube and immediately placed in an oil bath at 90° C. Samples were taken using deoxygenated gas tight syringe and immediately quenched by freezing in liquid nitrogen. The reaction was terminated by cooling rapidly and subsequent exposure to air.

No polymerization was observed after 48 hours.

Initiator A, N-Hydroxysuccinimide Methacrylate, DMSO, No Pre-Incubation

Cu(I)Br (0.039 g, 2.72×10⁻⁴ mol), N-hydroxy succinimide methacrylate (5.0 g, 0.027 mol), Initiator A (0.082 g, 2.72×10⁻⁴ mol) and dimethylsulphoxide (10 mL) were added to a Schlenk tube sealed with a rubber septa and subsequently deoxygenated by three consecutive freeze, vacuum, nitrogen purge cycles. Once the solution was fully degassed N-(n-Propyl)-2-pyridylmethanimine (0.085 mL, 5.46×10⁻⁴ mol) was added by pre-dried gas tight syringe to the Schlenk tube and immediately placed in an oil bath at 90° C. Samples were taken using deoxygenated gas tight syringe and immediately quenched by freezing in liquid nitrogen. The reaction was terminated by cooling rapidly and subsequent exposure to air.

No polymerization was observed after 48 hours.

Initiator B, MMA, Toluene, No Pre-Incubation

Cu(I)Br (0.134 g, 9.36×10⁻⁴ mol), methyl methacrylate (10 mL, 9.35×10⁻² mol), Initiator B (0.294 g, 9.36×10⁻⁴ mol) and toluene (20 mL) were added to a Schlenk tube sealed with a rubber septa and subsequently deoxygenated by three consecutive freeze, vacuum, nitrogen purge cycles. Once the solution was fully degassed N-(n-Propyl)-2-pyridylmethanimine (0.290 mL, 1.87×10⁻³ mol) was added by pre-dried gas tight syringe to the Schlenk tube and immediately placed in an oil bath at 90° C. Samples were taken using deoxygenated gas tight syringe and immediately quenched by freezing in liquid nitrogen. The reaction was terminated by cooling rapidly and subsequent exposure to air.

No polymerization was observed after 48 hours.

Initiator A, MMA, Toluene, No Pre-Incubation

Cu(I)Br (0.134 g, 9.36×10⁻⁴ mol), methyl methacrylate (10 mL, 9.35×10⁻² mol), Initiator A (0.281 g, 9.36×10⁻⁴ mol) and toluene (20 mL) were added to a Schlenk tube sealed with a rubber septa and subsequently deoxygenated by three consecutive freeze, vacuum, nitrogen purge cycles. Once the solution was fully degassed N-(n-Propyl)-2-pyridylmethanimine (0.290 mL, 1.87×10⁻³ mol) was added by pre-dried gas tight syringe to the Schlenk tube and immediately placed in an oil bath at 90° C. Samples were taken using deoxygenated gas tight syringe and immediately quenched by freezing in liquid nitrogen. The reaction was terminated by cooling rapidly and subsequent exposure to air.

No polymerization was observed after 48 hours.

MMA Compound A, Ethyl 2-Bromoisobutyrate, Toluene, No Pre-Incubation

Cu(I)Br (0.134 g, 9.36×10⁻⁴ mol), methyl methacrylate (10 mL, 9.35×10⁻² mol), ethyl-2-bromoisobutyrate (0.137 mL, 9.36×10⁻⁴ mol), compound A (200 mg) and toluene (20 mL) were added to a Schlenk tube sealed with a rubber septa and subsequently deoxygenated by three consecutive freeze, vacuum, nitrogen purge cycles. Once the solution was fully degassed N-(n-Propyl)-2-pyridylmethanimine (0.290 mL, 1.87×10⁻³ mol) was added by pre-dried gas tight syringe to the Schlenk tube and immediately placed in an oil bath at 90° C. Samples were taken using deoxygenated gas tight syringe and immediately quenched by freezing in liquid nitrogen. The reaction was terminated by cooling rapidly and subsequent exposure to air.

The reaction proceeded as expected with linear kinetics and the resultant polymer having a narrow polydispersity and molecular weight consistent with the theoretical value obtained from conversion.

MMA, Initiator B, Toluene, Pre-Incubation at Lower Temperature

Cu(I)Br (0.134 g, 9.36×10⁻⁴ mol), methyl methacrylate (10 mL, 9.35×10⁻² mol), Initiator B (0.290 g, 9.36×10⁻⁴ mol) and toluene (20 mL) were added to a Schlenk tube sealed with a rubber septa and subsequently deoxygenated by three consecutive freeze, vacuum, nitrogen purge cycles. Once the solution was fully degassed N-(n-Propyl)-2-pyridylmethanimine (0.290 mL, 1.87×10−3 mol) was added by pre-dried gas tight syringe to the Schlenk tube and placed in an oil bath at ambient room temperature. The temperature of the oil bath was then raised to 90° C. over approximately 1 hour. Samples were taken using deoxygenated gas tight syringe and immediately quenched by freezing in liquid nitrogen. The reaction was terminated by cooling rapidly and subsequent exposure to air.

After 5 hours the polymerization reached 40% conversion, the molecular weight (Mn) was 26,300 and PDi 1.30. The molecular weight is much higher than expected from the conversion reached indicating poor initiator efficiency.

MMA, Initiator A, Toluene Pre-Incubation at Lower Temperature

Cu(I)Br (0.134 g, 9.36×10⁻⁴ mol), methyl methacrylate (10 mL, 9.35×10⁻² mol), Initiator A (0.281 g, 9.36×10⁻⁴ mol) and toluene (20 mL) were added to a Schlenk tube sealed with a rubber septa and subsequently deoxygenated by three consecutive freeze, vacuum, nitrogen purge cycles. Once the solution was fully degassed N-(n-Propyl)-2-pyridylmethanimine (0.290 mL, 1.87×10⁻³ mol) was added by pre-dried gas tight syringe to the Schlenk tube and placed in an oil bath at ambient room temperature. The temperature of the oil bath was then raised to 90° C. over approximately 1 hour. Samples were taken using deoxygenated gas tight syringe and immediately quenched by freezing in liquid nitrogen. The reaction was terminated by cooling rapidly and subsequent exposure to air.

After 5 hours the polymerization reached 21% conversion, the molecular weight (Mn) was 36,500 and PDi 1.42. The molecular weight is much higher than expected from the conversion reached indicating poor initiator efficiency.

CuCl, MMA, Initiator B, Pre-Incubation at Lower Temperature

Cu(I)Cl (0.09 g, 9.36×10⁻⁴ mol), methyl methacrylate (10 mL, 9.35×10⁻² mol), Initiator B (0.290 g, 9.36×10⁻⁴ mol) and toluene (20 mL) were added to a Schlenk tube sealed with a rubber septa and subsequently deoxygenated by three consecutive freeze, vacuum, nitrogen purge cycles. Once the solution was fully degassed N-(n-Propyl)-2-pyridylmethanimine (0.290 mL, 1.87×10⁻³ mol) was added by pre-dried gas tight syringe to the Schlenk tube and placed in an oil bath at ambient room temperature. The temperature of the oil bath was then raised to 90° C. over approximately 1 hour. Samples were taken using deoxygenated gas tight syringe and immediately quenched by freezing in liquid nitrogen. The reaction was terminated by cooling rapidly and subsequent exposure to air.

After 21 hours the polymerization reached 18% conversion, the molecular weight (Mn) was 9,360 and PDi 1.20. The molecular weight is much higher than expected from the conversion reached indicating poor initiator efficiency.

MMA, Initiator A, Toluene, Pre-Incubation at Lower Temperature

Cu(I)Br (0.09 g, 9.36×10⁻⁴ mol), methyl methacrylate (10 mL, 9.35×10⁻² mol), Initiator A (0.281 g, 9.36×10⁻⁴ mol) and toluene (20 mL) were added to a Schlenk tube sealed with a rubber septa and subsequently deoxygenated by three consecutive freeze, vacuum, nitrogen purge cycles. Once the solution was fully degassed N-(n-Propyl)-2-pyridylmethanimine (0.290 mL, 1.87×10⁻³ mol) was added by pre-dried gas tight syringe to the Schlenk tube and placed in an oil bath at ambient room temperature. The temperature of the oil bath was then raised to 90° C. over approximately 1 hour. Samples were taken using deoxygenated gas tight syringe and immediately quenched by freezing in liquid nitrogen. The reaction was terminated by cooling rapidly and subsequent exposure to air.

After 21 hours the polymerization reached 24% conversion, the molecular weight (Mn) was 7,040 and PDi 1.37. The molecular weight was higher than expected from the conversion reached indicating poor initiator efficiency.

While this invention has been particularly shown and described with references to preferred embodiments thereof, it will be understood by those skilled in the art that various changes in form and details may be made therein without departing from the scope of the invention encompassed by the appended claims.

### REFERENCES

(1) Sawamoto, M.; Kato, M.; Kamigaito, M.; Higashimura, T. Macromolecules 1995, 28, 1721-1723.
(2) Matyjaszewski, K.; Patten, T. E.; Xia, J. J. Am. Chem. Soc. 1997, 119, 674-680.
(3) Percec, V.; Kim, H.-J.; Barboiu, B. Macromolecules 1997, 30, 6702-6705.
(4) Destarac, M.; Matyjaszewski, K.; Boutevin, B. Macromolecular Chemistry and Physics 2000, 201, 265-272.
(5) Petrucci, M. G. L.; Lebuis, A.; Kakkar, A. K. Organometallics 1998, 17, 4966-4975.
(6) Sawamoto, M.; Ando, T.; Kamigaito, M. Macromolecules 1997, 30, 4507-4510.
(7) Granel, C.; Teyssie, P.; DuBois, P.; Jerome, P. Macromolecules 1996, 29, 8576-8582.
(8) Kajiwara, A.; Matyjaszewski, K.; Kamachi, M. Macromolecules 1998, 31, 5695-5701.
(9) Louie, J.; Grubbs, R. B. Chemical Communications 2000, 16, 1479-1480.
(10) Kotani, Y.; Kamigaito, M.; Sawamoto, M. Macromolecules 1999, 32, 2420-2424.
(11) Ando, T.; Kato, M.; Kamigaito, M.; Sawamoto, M. Macromolecules 1996, 29, 1070-1072.
(12) Nishikawa, T.; Ando, T.; Kamigaito, M.; Sawamoto Macromolecules 1997, 30, 2244-2248.
(13) Takahashi, H.; Ando, T.; Kamigaito, M.; Sawamoto, M. Macromolecules 1999, 32, 3820-3823.
(14) Uegaki, H.; Kamigaito, M.; Sawamoto, M. Journal of Polymer Science Part a-Polymer Chemistry 1999, 37, 3003-3009.
(15) Matyjaszewski, K.; Jo, S. M.; Paik, H.-J.; Gaynor, S. G. Macromolecules 1997, 30, 6398-6400.
(16) Matyjaszewski, K.; Jo, S. M.; Paik, H. J.; Shipp, D. A. Macromolecules 1999, 32, 6431-6438.
(17) Percec, V.; Barboiu, B.; Bera, T. K.; van der Sluis, M.; Grubbs, R. B.; Frechet, J. M. J. Journal of Polymer Science Part a-Polymer Chemistry 2000, 38, 4776-4791.
(18) Feiring, A. E.; Wonchoba, E. R.; Davidson, F.; Percec, V.; Barboiu, B. Journal of Polymer Science Part a-Polymer Chemistry 2000, 38, 3313-3335.
(19) Percec, V.; Kim, H. J.; Barboiu, B. Macromolecules 1997, 30, 8526-8528.
(20) Haddleton, D. M.; Edmonds, R.; Heming, A. M.; Kelly, E. J.; Kukulj, D. N. J. Chem. 1999, 23, 477-479.
(21) Haddleton, D. M.; Ohno, K. Biomacromolecules 2000, 1, 152.
(22) Ayres, N.; Haddleton, D. M.; Shooter, A. J.; Pears, D. A. Macromolecules 2002, 35, 3849-3855.
(23) Jankova, K.; Chen, X. Y.; Kops, J.; Batsberg, W. Macromolecules 1998, 31, 538-541.
(24) Narain, R.; Armes, S. P. Macromolecules 2003, 36, 4675-4678.
(25) Haddleton, D. M.; Ohno, K.; Wong, B. Journal of Polymer Science Part a-Polymer Chemistry 2001, 39, 2206-2214.
(26) Angot, S.; Ayres, N.; Bon, S. A. F.; Haddleton, D. M. Macromolecules 2001, 34, 768-774.
(27) Perrier, S.; Jackson, S. G.; Haddleton, D. M.; Ameduri, B.; Boutevin, B. Macromolecules 2003, 36, 9042-9049.
(28) Dacros, V.; Haddleton, D. M. Macromolecules 2003, 39, 855-862.
(29) Huan, K.; Bes, L.; Haddleton, D. M.; Khoshdel, E. Journal of Polymer Science Part a-Polymer Chemistry 2001, 39, 1833-1842.
(30) Even, M.; Haddleton, D. M.; Kukulj, D. European Polymer Journal 2003, 39, 633-639.
(31) Senoo, M.; Kotani, Y.; Kamigaito, M.; Sawamoto, M. Macromolecules 1999, 32, 8005-8009.
(32) Xu, F. J.; Zhong, S. P.; Yung, L. Y. L.; Kang, E. T.; Neoh, K. G. Biomacromolecules 2004, 5, 2392-2403.
(33) Teodorescu, M.; Matyjaszewski, K. Macromolecular Rapid Communications 2000, 21, 190-194.
(34) Pai, T. S. C.; Barner-Kowollik, C.; Davis, T. P.; Stenzel, M. H. Polymer 2004, 45, 4383-4389.
(35) Barner, L.; Barner-Kowollik, C.; Davis, T. P.; Stenzel, M. H. Australian Journal of Chemistry 2004, 57, 19-24.
(36) Perrier, S.; Takolpuckdee, P.; Westwood, J.; Lewis, D. M. Macromolecules 2004, 37, 2709-2717.
(37) Takolpuckdee, P.; Westwood, J.; Lewis, D. M.; Perrier, S. Macromolecular Symposia 2004, 216, 23-35.
(38) Takolpuckdee, P.; Mars, C. A.; Perrier, S. Organic Letters 2005, 7, 3449-3452.
(39) Hawker, C. J.; Hedrick, J. L. Macromolecules 1995, 28, 2993-2995.
(40) Hawker, C. J.; Bosman, A. W.; Harth, E. Chemical Reviews 2001, 101, 3661-3688.
(41) Keller, R. N.; Wycoff, H. D. Inorg Synth. 1947, 2, 1.
(42) Haddleton, D. M.; Crossman, M. C.; Dana, B. H.; Duncalf, D. J.; Heming, A. M.; Kukulj, D.; Shooter, A. J. Macromolecules 1999, 32, 2110-2119.
(43) Haddleton, D. M.; Kukulj, D.; Duncalf, D. J.; Heming, A. M.; Shooter, A. J. Macromolecules 1998, 31, 5201-5205.
(44) Haddleton, D. M.; Heming, A. M.; Kukulj, D.; Jackson, S. G. Chem. Commun. 1998, 1719-1720.

What is claimed is:

1. A transition metal living free radical and/or atom transfer polymerisation process comprising the steps of:
(a) mixing (i) a transition metal living free radical and/or atom transfer radical catalyst, (ii) a plurality of polymerisable monomers, and (iii) an initiator comprising a transferable atom or group a to an amide group to form a mixture;
(b) incubating the mixture at a first temperature; and then
(c) raising the temperature of the mixture to a second temperature to allow polymerisation of the monomers to proceed to produce polymer.

2. A process according to claim 1, wherein the temperature of the mixture is raised by at least 40° C.

3. A process according to claim 1 wherein the initiator has a general formula: 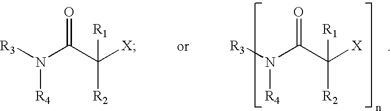
X is selected from Cl, Br, I, OR²⁰, SR²¹, SeR²¹, OP(═O)R²¹, OP(═O)R²¹, OP(═O)(OR²¹)₂, OP(═O)O²¹, O—N(R²¹)₂ and S—C(═S)N(R²¹)₂, where R²⁰=a C₁ to C₂₀ alkyl where one or more of the hydrogen atoms may be independently replaced by halide, R²¹ is aryl or a straight or branched C₁-C₂₀ alkyl group, and where an (NR²¹)₂ group is present, the two R²¹ groups may be joined to form a 5- or 6-membered heterocyclic ring; and
R₁, R₂, R₃ and R₄ are each independently selected from H, halogen, C₁-C₂₀ alkyl, C₃-C₈ cycloalkyl, C═YR²², C(═Y)NR²³R²⁴, COCl, OH, CN, C₂-C₂₀ alkenyl, C₂-C₂₀ alkynyl, oxiranyl, glycidyl, aryl, heterocyclyl, aralkyl, aralkenyl, C₁-C₆ alkyl in which 1 or more hydrogen atoms are replaced with halogen, substituted or non-substituted C₁ to C₂₀ alkyl interrupted by a disulphide link, and C₁ to C₆ alkyl substituted with from 1 to 3 substitutions selected from alkoxyl, aryl, heterocyclyl, C(═Y)R²², C(═Y)NR²³R²⁴, oxiranyl glycidyl;
where R²² is C₁ to C₂₀ alkyl, C₁ to C₂₀ alkoxy, aryloxy or heterocyclyloxy; and
R²³ and R²⁴ are independently H, C₁ to C₂₀ alkyl, or R²³ and R²⁴ may be joined together to form an alkylene group of 2 to 5 carbon atoms, thus forming a 3- to 6-membered ring;
where Y may be NR²⁵ or O, and R²⁵ is H, straight or branched C₁ to C₂₀ alkyl or aryl;
such that no more than three of R₁, R₂, R₃ and R₄ are H, and wherein R₃ and/or R₄ may additionally be a functional group, or a linker attached to a functional group, a polymer and/or a macromolecule; n is an integer of 2 to 100; and salts thereof.

4. A process according to claim 3, wherein the initiator has the formula 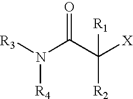
And R₁=methyl
R₂=H or methyl
R₃=H
R₄=—(CH₂)ₘ—S—S—C(CH₃)₃; where m=an integer of 1 to 16, preferably 1, 2 or 3.

5. A process according to claim 3, wherein R₃ and/or R₄ the macromolecule is a polymer.

6. A process according to claim 1, wherein the initiator is N-bensyl-2-bromo-2-methyl-propionamide, L-alanine-methylester-2-bromo-2-methyl-propionamide, or a difunctional bromoamide poly(dimethylsiloxane),

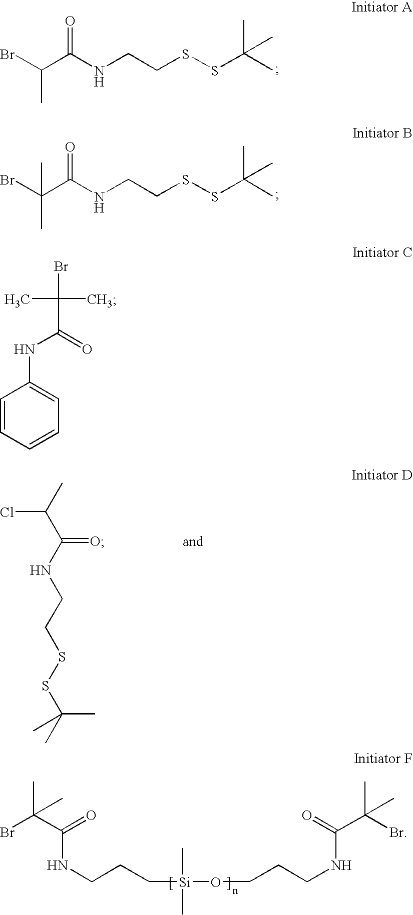

7. A process according to claim 3, wherein the functional group is a support or a detectable label.

8. A process according to claim 2, wherein the mixture is incubated for at least 5 minutes at the first temperature.

9. A process according to claim 8, wherein the mixture is incubated for less than 2 hours at the first temperature.

10. A process according to claim 9, wherein the temperature is raised from the first temperature to the second temperature at a rate of between 0.1° C. and 100° C. per minute.

11. A process according to claim 1, wherein the catalyst comprises a ligand which is any N—, O—, P— or S— containing compound which can coordinate in a δ-bond to a transition metal or any carbon-containing compound which can coordinate in a π-bond to the transition metal, such that direct bonds between the transition metal and growing polymer radicals are not formed.

12. A process according to claim 1, wherein the catalyst comprises:
(a) a first compound
MY
where:
M is a transition metal having an oxidation state which is capable of being oxidised by one formal oxidation state,
Y is a mono, divalent or polyvalent counterion; and
(b) an organodiimine, where at least one of the nitrogens of the diimine is not part of an aromatic ring.

13. A process according to claim 1, wherein the catalyst comprises a first component of formula:
[MLₘ]ⁿ⁺Aⁿ⁻
where:
M=a transition metal having an oxidation state which is capable of being oxidised by one formal oxidation state,
L=an organodiimine where at least one of the nitrogens of the diimine is not part of an aromatic ring,
A=anion,
n=integer of 1 to 3,
m=an integer of 1 or 2.

14. A process according to claim 13, wherein the transition metal is selected from Cu¹⁺, Cu²⁺, Fe²⁺, Fe³⁺, Ru²⁺, Ru⁺, Cr²⁺, Cr³⁺, Mo²⁺, Mo³⁺, W²⁺, W³⁺, Mn³⁺, Mn⁴⁺, R³⁺, Rh⁴⁺, Re²⁺, Re³⁺, Co⁺, Co²⁺, V²⁺, V³⁺, Zn⁺, Zn²⁺, Au⁺, A²⁺, Ag⁺ and Ag²⁺.

15. A process according to claim 1, wherein the monomer is selected from methyl methacrylate, ethyl methacrylate, propyl methacrylate (all isomers), butyl methacrylate (all isomers), and other alkyl methacrylates; corresponding acrylates; also functionalised methacrylates and acrylates including glycidyl methacrylate, trimethoxysilyl propyl methacrylate, allyl methacrylate, hydroxyethyl methacrylate, hydroxypropyl methacrylate, dialkylaminoalkyl methacrylates; nitrophenol (meth)acrylates; fluoroalkyl (meth)acrylates; methacrylic acid, acrylic acid; fumaric acid (and esters), itaconic acid (and esters), maleic anhydride; styrene, α-methyl styrene; vinyl halides such as vinyl chloride and vinyl fluoride; acrylonitrile, methacrylonitrile; vinylidene halides of formula CH₂═C(Hal)₂ where each halogen is independently Cl or F; optionally substituted butadienes of the formula CH₂═C(R¹⁵)C(R¹⁵)═CH₂ where R¹⁵ is independently H, C1 to C₁₀ alkyl, Cl, or F; sulphonic acids or derivatives thereof of formula CH₂═CHSO₂OM wherein M is Na, K, Li, N(R¹⁶)₄ where each acrylamide or derivatives thereof of formula CH₂═CHCON(R¹⁶)₂ and methacrylamide or derivative thereof of formula CH₂═C(CH₃)CON(R¹⁶)₂, R¹⁶ is independently H or Cl or alkyl, D is COZ, ON, N(R¹⁶)₂ or SO₂OZ and Z is H, Li, Na, K or N(R¹⁶)₄ and mixtures thereof.

16. A polymer produced by a process according to claim 1.

17. A polymer according to claim 16 comprising at least a portion of the amine initiator attached or incorporated into the polymer.

18. A polymer has a formula selected from: 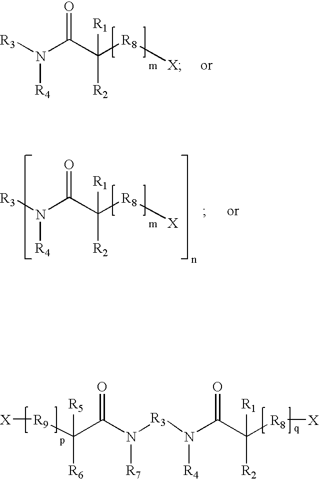
X is selected from Cl, Br, I, OR²⁰, SR²¹, SeR²¹, OP(═O)R²¹, OP(═O)R²¹, —OP(═O)(OR²¹)₂, OP(═O)O²¹, O—N(R²¹)₂ and S—C(═S)N(R²¹)₂, where R²⁰=a C₁ to C₂₀ alkyl where one or more of the hydrogen atoms may be independently replaced by halide, R²¹ is aryl or a straight or branched C₁-C₂₀ alkyl group, and where an (NR²¹)₂ group is present, the two R²¹ groups may be joined to form a 5- or 6-membered heterocyclic ring; and
R₁, R₂, R₃, R₄, R₅, R₆ and R₇ are each independently selected from H, halogen, C₁-C₂₀ alkyl, C₃-C₈ cycloalkyl, C═YR²², C(═Y)NR²³R²⁴, COCl, OH, CN, C₂-C₂₀ alkenyl, C₂-C₂₀ alkynyl, oxiranyl, glycidyl, aryl, heterocyclyl, aralkyl, aralkenyl, C₁-C₆ alkyl in which 1 or more hydrogen atoms are replaced with halogen, substituted or non-substituted C₁ to C₂₀ alkyl interrupted by a disulphide link, and C₁ to C₆ alkyl substituted with from 1 to 3 substitutions selected from alkoxyl, aryl, heterocyclyl, C(═Y)R²², C(═Y)NR²³R²⁴, oxiranyl, glycidyl;
where R²² is C₁ to C₂₀ alkyl, C₁ to C₂₀ alkoxy, aryloxy or heterocyclyloxy; and
R²³ and R²⁴ are independently H, C₁ to C₂₀ alkyl, or R²³ and R²⁴ may be joined together to form an alkylene group of 2 to 5 carbon atoms, thus forming a 3- to 6-membered ring;
where Y may be NR²⁵ or O, and R²⁵ is H, straight or branched C₁ to C₂₀ alkyl or aryl;
such that no more than three of R₁, R₂, R₃ and R₄ are H, and wherein R₃, R₄ and/or R₇ may additionally be a functional group or a linker attached to a functional group, a polymer or a macromolecule; n is an integer of 2 to 100.
and where R₈, R₉ and R₁₀ are selected from a polymer selected from the group consisting of methyl methacrylate, ethyl methacrylate, propyl methacrylate (all isomers), butyl methacrylate (all isomers), and other alkyl methacrylates; corresponding acrylates; also functionalised methacrylates and acrylates including glycidyl methacrylate, trimethoxysilyl propyl methacrylate, allyl methacrylate, hydroxyethyl methacrylate, hydroxypropyl methacrylate, dialkylaminoalkyl methacrylates; nitrophenol (meth)acrylates; fluoroalkyl (meth)acrylates; methacrylic acid, acrylic acid; fumaric acid (and esters), itaconic acid (and esters), maleic anhydride; styrene, α-methyl styrene; vinyl halides such as vinyl chloride and vinyl fluoride; acrylonitrile, methacrylonitrile; vinylidene halides of formula CH₂═C(Hal)₂ where each halogen is independently Cl or F; optionally substituted butadienes of the formula CH₂═C(R¹⁵)C(R¹⁵)═CH₂ where R¹⁵ is independently H, C1 to C10 alkyl, Cl, or F; sulphonic acids or derivatives thereof of formula CH₂═CHSO₂OM wherein M is Na, K, Li, N(R¹⁶)₄ where each R¹⁶ is independently H or Cl or alkyl, D is COZ, ON, N(R¹⁶)₂ or SO₂OZ and Z is H, Li, Na, K or N(R¹⁶)₄; or
mixtures of such monomers; and m, p and q are independently selectable and are an integer of 1 to 10,000; and salts thereof.

19. A polymer according to claim 16, wherein the polymer has a polydispersity of less than 3.

20. An amide initiator having a formula selected from: 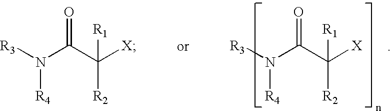
X is selected from Cl, Br, I, OR²⁰, SR²¹, SeR²¹, OP(═O)R²¹, OP(═O)R²¹, OP(═O)(OR²¹)₂, OP(═O)O²¹, O—N(R²¹)₂ and S—C(═S)N(R²¹)₂, where R²⁰=a C₁ to C₂₀ alkyl where one or more of the hydrogen atoms may be independently replaced by halide, R²¹ is aryl or a straight or branched C₁-C₂₀ alkyl group, and where an (NR²¹)₂ group is present, the two R²¹ groups may be joined to form a 5- or 6-membered heterocyclic ring; and
R₁, R₂, R₃ and R₄ are each independently selected from H, halogen, C₁-C₂₀ alkyl, C₃-C₈ cycloalkyl, C═YR²², C(═Y)NR²³R²⁴, COCl, OH, CN, C₂-C₂₀ alkenyl, C₂-C₂₀ alkynyl, oxiranyl, glycidyl, aryl, heterocyclyl, aralkyl, aralkenyl, C₁-C₆ alkyl in which 1 or more hydrogen atoms are replaced with halogen, substituted or non-substituted C₁ to C₂₀ alkyl interrupted by a disulphide link, and C₁ to C₆ alkyl substituted with from 1 to 3 substitutions selected from alkoxyl, aryl, heterocyclyl, C(═Y)R²², C(═Y)NR²³R²⁴, oxiranyl, glycidyl;
where R²² is C₁ to C₂₀ alkyl, C₁ to C₂₀ alkoxy, aryloxy or heterocyclyloxy; and
R²³ and R²⁴ are independently H, C₁ to C₂₀ alkyl, or R²³ and R²⁴ may be joined together to form an alkylene group of 2 to 5 carbon atoms, thus forming a 3- to 6-membered ring;
where Y may be NR²⁵ or O, and R²⁵ is H, straight or branched C₁ to C₂₀ alkyl or aryl;
such that no more than three of R₁, R₂, R₃ and R₄ are H, and wherein R₃ and/or R₄ may additionally be a functional group or a linker attached to a functional group, a polymer or a macromolecule; n is an integer of 2 to 100.

21. An initiator according to claim 20, wherein the initiator has the formula 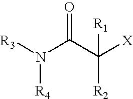
And R₁=methyl
R₂=H or methyl
R₃=H
R₄=—(CH₂)ₘ—S—S—C(CH₃)₃
where m=an integer of 1 to 16, preferably 1, 2 or 3.

22. An initiator according to claim 20, wherein the initiator is not N,N-dimethyl-2-chloropropionamide, a difunctional bromoamide poly(dimethyl siloxane) or comprise a silicone surface.

23. An amide initiator according to claim 20 selected from N-bensyl-2-bromo-2-methyl-propionamide and L-alanine-methylester-2-bromo-2-methyl-propionamide, [chemical structure]
